(19) United States
(12) Patent Application Publication
(10) Pub. No.: US 2020/0082442 A1
(43) Pub. Date: Mar. 12, 2020

(54) SYSTEMS APPARATUS AND METHODS FOR MANAGEMENT AND DISTRIBUTION OF VIDEO CONTENT

(71) Applicant: Leonard Z. SOTOMAYOR, New York, NY (US)

(72) Inventor: Leonard Z. SOTOMAYOR, New York, NY (US)

(21) Appl. No.: 16/138,866

(22) Filed: Sep. 21, 2018

Related U.S. Application Data
(63) Continuation-in-part of application No. 15/709,445, filed on Sep. 19, 2017.
(60) Provisional application No. 62/561,543, filed on Sep. 21, 2017.

(51) Int. Cl. G06Q 30/02

(52) U.S. Cl. CPC G06Q 30/0269; G06Q 30/0255; G06Q 30/0267

(57) ABSTRACT

A system, apparatus and method are disclosed for distributing and displaying advertising videos on mobile devices. A buyer generates a profile containing a list of preferred purchases or vendors. The buyer's preferred profile entries are further associated with a geographic area. A mobile network is used to distribute seller's advertising content related to those preferred profile entries. A mobile network is used to provide advertising videos to mobile buyers based on the buyer's preferred profile entries. A mobile application is engaged by the buyer to stream general video content using a mobile media player. An ad server on the mobile device controls the media server during the video streaming and replaces advertising content within the video stream with the buyer's advertising videos associated with the preferred profile entries.

### CROSS-REFERENCE TO RELATED APPLICATIONS

This application claims priority to and the benefit of U.S. patent application Ser. No. 15/709,445 filed on Sep. 19, 2017 titled “System and Method for Providing Seller's Offerings” and U.S. Provisional Patent Application No. 62/561,543 filed on Sep. 21, 2017 titled “Systems Apparatus and Methods for Management and Distribution of Video Content” the entire contents of each of which is incorporated by reference herein in their entirety.

### COPYRIGHT & TRADEMARK/TRADENAME NOTICES

A portion of the disclosure of this patent document may contain material, which is subject to copyright protection. The owner has no objection to the facsimile reproduction by any one of the patent documents or the patent disclosure, as it appears in the Patent and Trademark Office patent file or records, but otherwise reserves all copyrights whatsoever.

Certain marks referenced herein may be common law or registered trademarks of the applicant, the assignee or third parties affiliated or unaffiliated with the applicant or the assignee. Use of these marks is for providing an enabling disclosure by way of example and shall not be construed to exclusively limit the scope of the disclosed subject matter to material associated with such marks.

### BACKGROUND OF THE INVENTION

### 1. Field of the Invention

### 1. Field of the Invention

Privacy concerns regarding mobile device data have recent emerged in national discussions regarding individuals' always-on, internet-connected world. Mobile device users increasingly desire more control over their own user information; information which may be personal in nature, such as location-based information captured by mobile applications and shared with third-parties. Many mobile device users do not know exactly what information is being collected, what information is being shared, and how the information is being used. Location information of mobile devices is conventionally captured directly from the device, for example, from the GPS tracking applications the mobile device's managed connections to cellular towers, GPS satellite tracking sites, or reverse internet protocol (IP) address look-up services. In each of these inadvertent connections, personal information is being accessed on the users' mobile devices including possibly phone contact information, mobile web browsing history, IP addresses visited, and mobile device identifying numbers, to name just a few. Several recent high-profile examples of a mobile application mishandling a mobile device user's personal data have had a negative impact on consumer trust as advertisers and promoters are utilizing and exploiting ever increasing collections of mobile device user data in an attempt to create location-based advertising for mobile customers.

Apart from the mobile data collection problem, the actual display of mobile advertising has itself become a nuisance to mobile device users. Various mobile device display methodologies are now used to attract the mobile users' attention in this regard, such as banner display advertising and push notification windows, similar to pop up windows on a desktop computing device. In most instances, mobile advertisements are neither relevant to the mobile device user nor are they desired or solicited by the user. As a further complication, the smaller mobile device displays easily become crowded when random asynchronous information is constantly presented to and displayed on the mobile device. Consequently, conventional advertising networks used for mobile ad delivery suffer from at least three shortcomings: 1) they carry a high nuisance factor in delivering useful ads; 2) they compromise the privacy of the mobile device user in exchange for the display of those advertisements; and 3) they potentially create negative user impressions based on these problems.

### 2. Description of Related Art

Many advertising systems presently rely on tracking a user and collecting the user's mobile device information on a centralized ad server. This information is then sorted and analyzed to deliver targeted advertisements to the user. U.S. Patent Appln. Pub. No. US 2010/0138294 A1, to Bussmann, et al. and published on Jun. 3, 2010 (hereinafter Bussmann, et al.), discloses one such system. In Bussmann, et al., a location-based advertising server is used to collect ad content from advertising publishers associated with a particular geographic region. (Abstract) The system of Bussmann, et al. then collects bids for placing that content along with requests from mobile devices within the specified geographic area for delivering advertising content. The advertising system of Bussmann, et al. matches device request for ad content associated with the geographic area and delivers ad content based on bid prices offered by the advertisers.

The system of Bussmann, et al. provides the mobile device user with no direct control over the ad content received except as to its geographic proximity to the user. A better functioning system would permit a mobile device user's advertising needs to be directly presented to an ad server which then requests, specific, tailored ads from the advertisers. What is desired, on the part of both the buyer and seller, is a push dynamic in creating a type of “specific channel relationship” between them. This “channel relationship” is solidified when the above-mentioned privacy concerns are addressed. Just as in the purely physical shopping world, the best buying experiences are obtained when highly relevant delivery of ad content and offerings are presented to the user at precisely the moment in time in which the user is most engaged with the shopping, planning and decision-making processes.

U.S. Pat. Appln. Pub. No. US 2011/0295687 A1, to Bilenko, et al. and published on Dec. 1, 2011 (hereinafter Bilenko, et al.) discloses a system in which user profiles are introduced for tailoring delivered ad content. (Abstract.) In Bilenko, et al., the user profile is used as a factor in selecting ads to be forwarded to the user. (Abstract.) However, the system disclosed in Bilenko, et al. allows user profiles and past purchase histories unique to the users to be shared with the ad content providers, thereby violating the privacy concerns that are the subject of the present invention. (Bilenko, et al., p. 4, para. [0023].)

U.S. Pat. Appln. Pub. No. US 2007/0130005 A1, to Jaschke and published on Jun. 7, 2007 (hereinafter Jaschke), is similarly deficient in collecting and using the personal information of the user in the advertising bidding process. Specifically, highly personal data is collected by the advertising server including age, gender, ethnic group, income, etc. (See FIG. 3 and related description.) The consumer information broker of Jaschke then filters the user profile information and correlates this private user data with a target profile created by the advertiser to determine a winning bidder. (Jaschke, p. 4, paras. [0059] and [0067].) While the advertiser never “sees” or receives the user's personal information as part of the ad selection process, that information is used, nonetheless, by the system of Jaschke to initially screen and match mobile users having profiles containing sensitive information with the advertisers' target profiles. Further, while Jaschke discloses that users may opt-out of this targeted profile bidding process, (Jaschke, p. 6, para. [0080]), that information is nonetheless collected and stored on the advertiser's ad server as part of the overall system operation.

Other inventions have managed some aspects of an anonymous profile, but without consideration of mobile users' specific requested content. U.S. Pat. Appln. Pub. No. US 2009/0247193 A1, to Kalavade and published on Oct. 1, 2009, is one such invention. (See Abstract.) The patent application of Kalavade discloses a detailed process for the real-time creation of an anonymous user profile. (Kalavade, FIG. 1 and p. 3, paras. [0067]-[0076].) However, only when the users opt out of personal information sharing is the profile kept confidential. (Kalavade, p. 3, para. [0072]). The data processing of Kalavade, however, all this takes place with respect to user data collected in real-time but without any consideration of the specific ads that the mobile user is interested in receiving, and particularly without any connection to user-specified geographic areas of advertising interest.

Thus, it is an object of this invention, and a failure of the prior art to-date, to deliver user-specified advertising content to the mobile device of those users such that the ad content 1) satisfies a user request or specification for the ad; 2) is provided within a geographical area in which the user is interested in shopping, and 3) is provide in a manner that adequately preserves the privacy of the user's mobile device data.

### BRIEF SUMMARY OF THE INVENTION

According to one particularly preferred embodiment of the system of the present invention is presented a computer-based distribution system for providing advertising videos to buyers within the system, the computer-based distribution system including a computer-based mobile network, the computer-based distribution system including: at least one computer-based mobile device used by a buyer within the system, the buyer mobile device coupled to the computer-based mobile network, the mobile device including a processor and an associated memory for storing instructions executed by the processor; the mobile device using the processor for executing programs on the mobile device, the mobile device having: an ad server programmed as software application operating on the mobile device; a local database coupled to the ad server, the local database configured to store buyer profile data elements, the buyer profile data elements including buyer-specified advertising content, including at least one of a seller, a product or a service, the buyer profile data elements also including a buyer-specified geographic area, the buyer profile data elements including the preferred offerings of the buyer; a media player coupled to the ad server, the media player programmed as software application operating on the mobile device, the media player capable of being controlled by the ad server; an external application coupled to the media player, the external application programmed as software application operating on the mobile device, the external application programmed to play video streams on the mobile device, the video stream including video program content and advertising video content, the external application using the media player to play the video stream; and a user interface coupled to the ad server, the user interface used by the buyer to store the buyer profile data elements in the local database, the user interface being used to control the media player and the external application and play video streams on the mobile device; at least one computer-based advertising video distribution system operated by an advertising video provider within the distribution system, the advertising video distribution system coupled to the computer-based mobile network, the advertising video distribution system providing the advertising video content, including advertising videos, to the mobile device over the mobile network, the external application using the provided advertising video content and the provided advertising videos within the video streams played by the external application using the media player; and wherein the ad server stores advertising videos played by the buyer on the mobile device in the local database based on the preferred offerings of the buyer, the advertising video distribution system transmitting advertising videos to the mobile device, the advertising videos within the advertising video content played by the external application on the mobile device using the media player, the ad server replacing at least one of the provided advertising videos with the advertising videos associated with the preferred offerings of the buyer.

According to a specific variation of the method of the present invention the system is presented wherein the preferred offerings includes a buyer profile data element including a retail store at a geographic area, the retail store distributing an advertising video on the mobile network, the buyer using the mobile device to play the advertising video of the retail store, the ad server storing the advertising video of the retail store in the local database, the ad server replacing the provided advertising video with the advertising video of the retail store when the buyer is in the geographic area and the external application is playing a video stream with the media server on the mobile device.

According to one particularly preferred embodiment of the method of the present invention is presented a computer-implemented method is provided for providing advertising videos to buyers within a computer-based distribution system, the computer-based distribution system including a computer-based mobile network, the computer based mobile network coupled to a computer-based mobile device and at least one computer-based advertising video distribution system operated by an advertising video provider, each computer-based device, server and system having a processor and an associated memory for storing instructions executed by the processors, the mobile device using the processor for executing programs on the mobile device, the method including: activating a user interface on the mobile device by a buyer; storing buyer profile data elements in a local database on the mobile device by the buyer using the user interface, the buyer profile data elements being stored using an ad server on the mobile device coupled to the local database, the ad server programmed as a software application operating on the mobile device, the buyer profile data elements including buyer-specified advertising content, including at least one of a seller, a product or a service, the buyer profile data elements also including a buyer-specified geographic area, the buyer profile data elements including preferred offerings of the buyer; storing with the ad server advertising videos played by the buyer on the mobile device in the local database, the stored advertising videos based on the preferred offerings of the buyer; playing a video stream with an external application on the mobile device, the external application programmed as a software application operating on the mobile device, the video stream including video program content and advertising video content, the external application using a media player to play the video stream, the media player programmed as a software application operating on the mobile device, the media player capable of being controlled by the ad server; transmitting over the mobile network with the advertising video distribution system advertising video content to the mobile device over the mobile network, the advertising video content including advertising videos; receiving over the mobile network at the mobile device and the external application the advertising video content and the advertising videos; and replacing with the media player under the control of the ad server at least one of the transmitted advertising videos with the advertising videos associated with the preferred offerings of the buyer during the playing of the video stream.

According to a specific variation of the method of the present invention, the method further including replacing all the transmitted advertising videos with the advertising videos associated with the preferred offerings.

According to another particular preferred embodiment of the previously provided method, a non-transitory, machine-readable storage media having executable instructions for causing a plurality of processors within a plurality of computers to perform the same method.

### BRIEF DESCRIPTION OF THE SEVERAL VIEWS OF THE DRAWING(S)

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is an overall system network diagram illustrating various aspects of one particularly preferred embodiment of the invention;

FIG. 2 is a data diagram illustrating data elements used by the user's mobile devices according to one particularly preferred embodiment of the invention;

FIG. 3 is a data diagram illustrating data elements used by the seller dashboard according to one particularly preferred embodiment of the invention;

FIG. 4 is a block diagram example of a physical location device according to one particularly preferred embodiment of the invention;

FIG. 5 is a geographical peer-to-peer network representation of a plurality of the physical location devices according to one particularly preferred embodiment of the present invention;

FIG. 6 shows a geographic depiction of the operation of the present invention according to one preferred embodiment;

FIG. 7 shows another geographic depiction of the operation of the present invention according to another preferred embodiment;

FIG. 8 shows another geographic depiction of the operation of the present invention according to another preferred embodiment;

FIG. 9 shows another geographic depiction of the operation of the present invention according to another preferred embodiment

FIG. 10 shows another geographic depiction of the operation of the present invention according to another preferred embodiment

FIGS. 11 shows another geographic depiction of the operation of the present invention according to another preferred embodiment;

FIG. 12 another geographic depiction of the operation of the present invention according to another preferred embodiment;

FIG. 13 shows a data diagram illustrating data elements used by the seller bidding panel according to one particularly preferred embodiment of the invention;

FIG. 14 shows another data diagram illustrating data elements used by the seller bidding panel according to another particularly preferred embodiment of the invention;

FIG. 15 shows a data diagram illustrating data elements used by the user's mobile devices in connection with the data contained in FIGS. 13 and 14 and according to one particularly preferred embodiment of the invention;

FIG. 16 shows a mobile device display according to one particularly preferred embodiment of the invention;

FIGS. 17A and 17B show a pair of mobile device displays illustrating a sequence of consecutive actions taken by the user according to one particularly preferred embodiment of the invention;

FIGS. 18A-D show a series of mobile device displays illustrating a sequence of consecutive actions taken by the user according to one particularly preferred embodiment of the invention;

FIGS. 19A-19C show a series of mobile device displays illustrating a sequence of consecutive actions taken by the user according to one particularly preferred embodiment of the invention;

FIGS. 20A-20C shows another series of mobile device displays illustrating a sequence of consecutive actions taken by the user according to one particularly preferred embodiment of the invention;

FIGS. 21A and 21B show a series of mobile device displays illustrating a sequence of consecutive actions taken by the user according to one particularly preferred embodiment of the invention;

FIGS. 22A and 22B show a series of mobile device displays illustrating a sequence of consecutive actions taken by the user according to one particularly preferred embodiment of the invention;

FIG. 23A-C show video streaming and data diagrams illustrating certain aspects in the creation of an advertising video chain according to one particularly preferred embodiment of the invention;

FIG. 24A is a video data diagram showing the overall data structure of the video ad types that are included within a broadcast video stream according to one particularly preferred embodiment of the invention;

FIGS. 24B-24D are video data diagrams showing the progression of video streaming associated with multiple mobile devices according to one particularly preferred embodiment of the invention; and

FIG. 25 shows a tabular display of the advertising video data usage metrics according to one embodiment of the present invention streaming.

### DETAILED DESCRIPTION OF THE INVENTION

To facilitate a clear understanding of the present invention, illustrative examples are provided herein which describe certain aspects of the invention. However, it is to be appreciated that these illustrations are not meant to limit the scope of the invention and are provided herein to illustrate certain concepts associated with the invention.

It is also to be understood that certain aspects of the present invention may be implemented in various forms of hardware, software, firmware, special purpose processors, or a combination thereof. Preferably, certain aspects of the present invention may be implemented in software as a program tangibly embodied on a program storage device. The program may be uploaded to, and executed by, an electronic machine comprising any suitable architecture. Preferably, certain aspects of the invention are implemented on a computer platform having hardware such as one or more central processing units (CPU), a random-access memory (RAM), and input/output (I/O) interface(s). The computer platform may also include an operating system and microinstruction code. The various processes and functions described herein may either be part of the microinstruction code or part of the program (or combination thereof) which is executed via the operating system. In addition, various other peripheral devices may be connected to the computer platform such as an additional data storage device and a printing device.

It is to be understood that, because some of the constituent system components and method steps depicted in the accompanying figures are preferably implemented in software, the actual connections between the system components (or the process steps) may differ depending upon the manner in which the present invention is programmed. Specifically, any of the computers or devices may be interconnected using any existing or later-discovered networking technology and may also all be connected through a lager network system, such as a corporate network, metropolitan network or a global network, such as the internet.

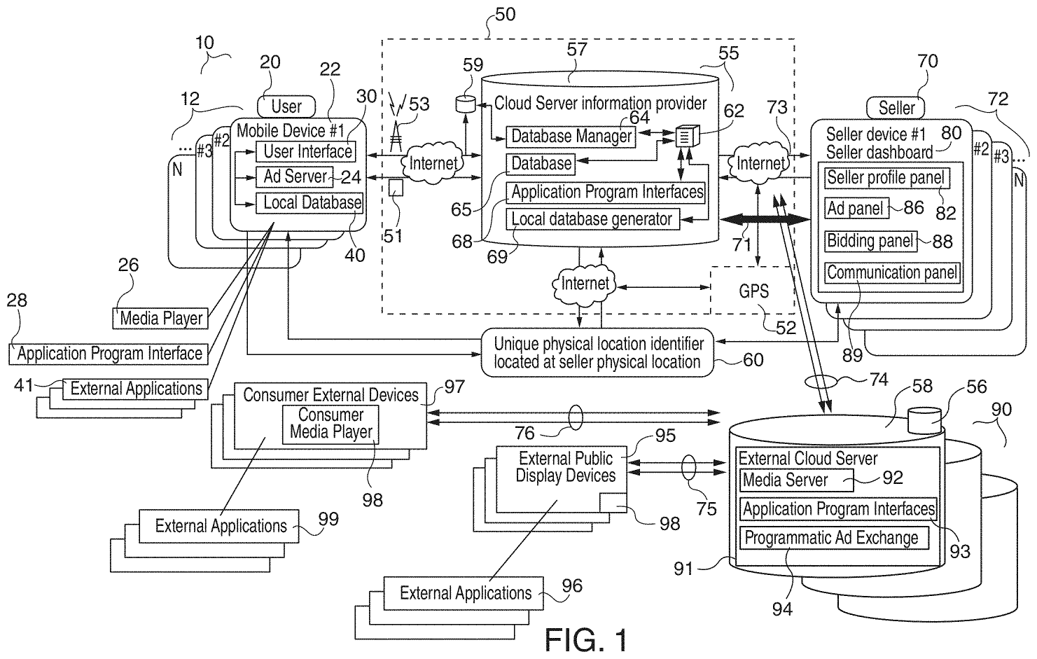

FIG. 1 shows a block diagram of the overall mobile purchasing system 10 of the present invention. System 10 includes a plurality of computer systems, mobile devices and mobile information networks. Mobile network 50 is provided as the central information conduit that connects mobile users having a plurality of mobile devices 12 to sellers (alternatively vendors) having a plurality of sales promotion devices 72. A GPS or location determining network 52 is included as an additional mobile network component within mobile network 50 and is also connected to the plurality of user mobile devices 12 and to the plurality of sales promotion devices 72. Physical location devices 60 are electronic devices that are connected to the mobile network 50 and are sited at a particular geographic location. Physical location devices 60 are capable of wirelessly transmitting the certain information to the mobile devices 12 when those devices are within an appropriate range of the physical location device and are typically associated with a non-mobile seller.

It should be noted that while the specific examples provided herein are primarily directed to mobile devices operating within a mobile network, the general concepts of the system disclosed in this invention may be equally applied to any non-mobile devices connected to an associated network and where the associated network possesses similar system architectures and functional capabilities. Further, the actual mobile connections illustrated herein may be any one of, or combination of, known or later-developed mobile access technologies, including by not limited to: cellular mobile, Wi-Fi, PAN, RFID, Bluetooth, NFC, radio, IR, and satellite. Finally, as used herein, the term “mobile network” 50 is used to denote the sum of the wireless access devices and the entire network to which they provide wireless access. That means that the “mobile network” is the entire network found behind and including the sum of wireless access points and to which a mobile device may connect using any of the supported communications protocols. In this regard, the wireless network includes wireless and wired devices behind the wireless access cloud. The “mobile network” may be proprietary, a public cloud network or it may be considered to include the entire web or internet. In sum, the mobile network is the totality of all networked devices for which wireless access is permitted such that any mobile device may be provided access to public portions or user specific portions of the interconnected devices comprising both the wired and mobile portions of the network.

Mobile device 22 is employed by a user or buyer 20 (used interchangeably) to perform any of the numerous and varied functions that mobile devices are capable of performing. By way of example and not limitation, mobile device 22 may be a smart phone, a tablet, wireless access device, fob, a portable or non-portable personal computer, or a smart television. Mobile device 22 is connected to the mobile network 50 in one of two ways. It may be connected directly, by cellular or satellite connection offered by a telecommunications or broadband information provider, for example, typically through the use of large and powerful network antenna structures 53. Alternatively, mobile device 12 may be connected indirectly to the mobile network through a wireless access gateways or wireless broadband modems 51 that, in turn connect to the internet through other wired and wireless connections. User 20 is capable of employing its mobile device 22 in any manner desirable and typical, for example, to use the mobile network to conduct telecommunications (e.g. making telephone calls), consume information content (e.g. streaming video, reading news articles) or conduct commerce (e.g. view advertisements, place orders).

The prototypical mobile device 22 is a “smart phone,” a small handheld mobile computer that is capable of performing telecommunications functions. The mobile computer typically includes at least one processor and associated memory in which stored programs reside and from which the processor executes the program steps for those programs to effect the operations performed by the mobile device. The software on the mobile device may take the form of either stand-alone software that executes solely on the mobile device or in the form of small program software application components (apps or applets). In either case, data on which the standalone programs or apps operate may be provided by any of a number of sources, such as being input by the user 20, generated from within the mobile device (e.g. via numerical computations) or provided to the mobile device 22 over the wireless connection to that device by devices within the mobile network. Most relevant to the present invention, mobile device 22 contains a stored program, preferably an app, to create and manage consumer purchase decisions according to the preferred embodiments of the invention. In either stand-alone or app software configurations, the stored program for managing these consumer purchases is programmable, configurable, and otherwise capable of being controlled by the user.

To accomplish the consumer management function, mobile device 22 includes a user interface (UI) 30, an ad server 24 and a local database 40. As described in more detail below user 20 accesses mobile device 22 through the UI 30. The consumer's purchase data itself is stored on the local database 40 and is provided by any of a number of sources including user 20, the mobile device 22 itself and sources from with the mobile network. Ad server 24 exercises programmed control over the local database 40 under the direction of the user interface 30. Further, the ad server coordinates and executes most all of the user data management functions in relation to the display and management of the advertisements received by the user as described in more detail below.

In relevant aspects, mobile network 50 may include information or internet service providers (ISPs) 55 that operate a cloud 57 in the form of cloud servers 62, external cloud storage 59 and other associated apparatus. Verizon, AT&T and Comcast are typical examples of internet service providers as they provide commercial access to the internet and cloud as well as providing data storage and services related to that access. Google and HP are typical examples of information services providers as the provide cloud-based computing and development environments, associated data storage and universal internet access capabilities to internet users. Specifically, database manager 64 may be part of the hardware and software operating on cloud server 62 to control the internal cloud storage on one or more databases 65. Application program interfaces 68 are provided for various external software developers to plug into the cloud software and access the cloud data. A local database generator 69 is coupled to the cloud servers and to the mobile devices and their local databases outside the mobile network. The local database generator serves to provide independent access to and management of the data on the user devices and interacts directly with the user devices' local databases so to update the information therein, including the ability to access and manage database 65, possibly with the coordinated assistance of database manager 64, in the performance of those function. As a complementary component to the plurality of users and their mobile devices 22, the mobile system 10 includes a plurality of sales promotion devices 72, each associated with a seller 70. Like the mobile devices 22, the sales promotion devices 72 include a computer that may, optionally, be capable of performing telecommunications functions. The computer within the sales promotion device typically includes at least one processor and associated memory in which stored programs reside and from which the processor executes the program steps of those programs to effect the operations performed by the sales promotion device. The software on the seller dashboard device may take the form of either stand-alone software that executes solely on the sales promotion device or in the form of small program software application components (apps or applets). In either case, data on which the standalone programs or apps operate may be provided by any of a number of sources, such as being input by the seller 70, generated from within the sales promotion device (e.g. via numerical computations) or provided to the sale promotion device 72 over the wired connection 73 or wireless connection 71 that provides network connectivity to the sales promotion devices 72. Most relevant to the present invention, sales promotion device 72 contains a seller dashboard 80 consisting essentially of a computer display coded in software on the sales promotion device. The display provides certain user interfaces, such as a seller profile panel 82, and ad panel 86 a bidding panel 88 and a communications panel 89. Each of these panels or displays is coded in software as a stored program operating on the sales promotion devices, and in sum, they act to create and manage the sales end of the distributed advertising according to the preferred embodiments of the invention. In either stand-alone or app software configurations, the stored program for managing these consumer purchases is programmable, configurable and otherwise capable of being controlled by the seller.

Before describing other portions of the invention, it is first useful to understand the business environment in which the present invention is intended to operate. The system of the present invention is designed and intended to match buyers that have indicated certain product or service preferences with sellers of the same. This matching function has several critical and unique aspects. First, the buyer's purchase preference data, and particularly the buyer's unique identification resides only on the buyer's mobile devices. To the extent that any buyer data is shared with the seller, it is done so without unique reference to the individual buyers. Second, the sellers are located in a particular geographical area; an area identified by the buyer as being one that is often frequented by the buyer and therefore, an area that is ideal for the identification of appropriate purchase opportunities based on the buyer's preferences. Third, the mobile network is integral to matching buyer and seller data. Each of the buyer and seller are somewhat agnostic as to the means by which they are matched, as long at the confidentiality of the buyer's uniquely identifying information is preserved and the seller has an opportunity to potentially increase sales by targeting buyers that have identified them as a preferred vendor, or by various other means as further discussed below.

On the sellers' side, the system of the present invention is particularly useful to small and medium businesses (“SMBs”). These are typically businesses that have one or more physical locations, both permanent and temporary, where a buyer may view, order, and purchase goods and services. The SMBs are distinguished from the large, nation-wide, retail chains or franchised businesses in that they depend on local traffic for the majority of their sales opportunities. A cobbler or corner grocery stores within a major metropolitan area are prime examples of an SMB that would benefit from the system of the present invention. In either seller's case, the goods and services offered may exist and be offered for sale in both physical form (i.e. in store) and digital form (i.e. online). This is not to say that large retailers, which have greater marketing presence and typically extend their sales opportunities by simply attracting buyers to their large-box location, would not also find the system of the present invention useful. Since large retail chains also have physical locations, both permanent and temporary, a buyer may also add large retails chains for later purchase opportunities, most likely within preferred geographic areas set by the buyer. In this manner, destination places or destinations are thought of as physical locations, both permanent and temporary, where a user visits to order, shop, or purchase goods and services. Some examples of a permanent physical location include stores, malls, offices and amusement parks. Some examples of a temporary physical location include “pop-up” stores, concerts, trade shows, art fairs and mobile vending operations. Some examples of more permanent destination places are a large shopping mall, a city street or location, a strip mall, or any other specific point of commercial sale.

Since the present invention is essentially an advertising platform, the term brand is used as a name, term, design, symbol, or any other feature that distinctly identifies one company's goods or services from those of other companies. A brand might be a type of product manufactured by a particular company under a particular name. Examples of brands include, but are not limited to, national food service chains, hospitality chains, national and regional banks, automobile brands, household products and food products. As far as the advertising of the brand, each brand is competing for a buyer's time and attention in order to build relationships with their target audience(s) or buyers. A brand is the set of expectations, memories, stories and relationships that, taken together, account for a buyer's decision to choose one product or service over another. Seller and advertiser are used herein interchangeably and may be thought of as any of a SMB, large retailer, destination place, brand or any combination thereof

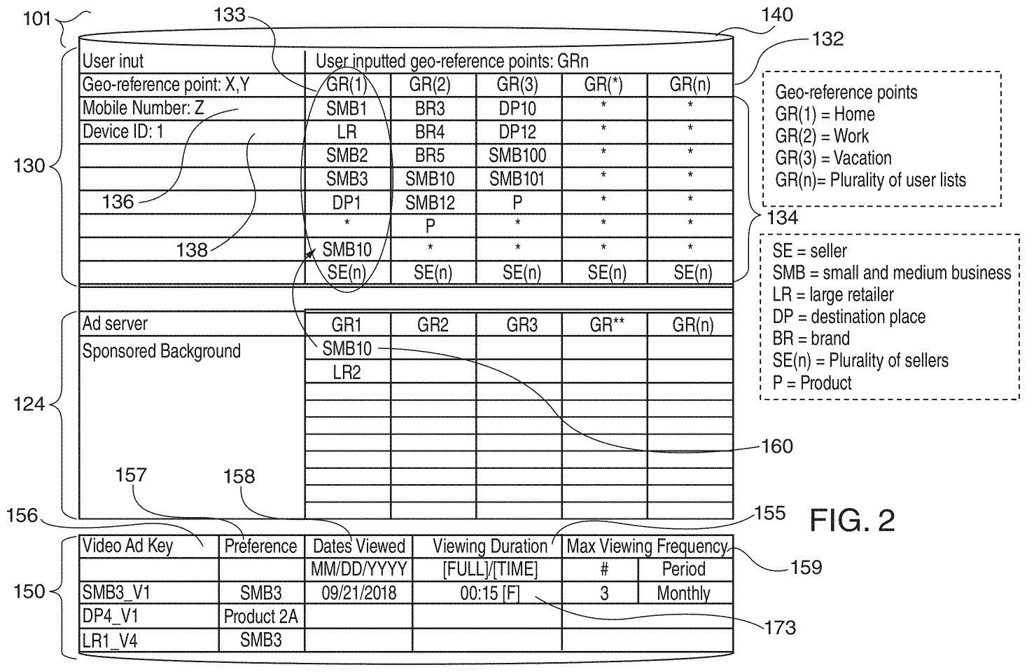

FIG. 2 is a data diagram 101 that shows a data-centric view of the data stored within buyer's mobile device 22. In particular, the data entered by the buyer 20 into mobile device 22 through the user interface 30 is shown at 130 and stored within local database 140. Non-user input data managed by the ad server is shown in section 124 and is also stored within local database 140. As part of the initialization of the database 140, the user 20 enters a plurality of geo-reference points 132. Each of the geo-reference points may be places or geographic areas in which the user is often located and in which he or she seeks purchasing opportunities. Examples of geo-reference points may include “home” locations, places of “work,” travel or vacation. Geo-reference points may be input in a variety of manners. One such mechanism would be to use GPS identification functions provided by the mobile device 22. In other situations, the user may manually input coordinates through the user interface. In any case, the user then inputs a preferred list of sellers including SMBs, destination places, and brands as shown in section 134. Since many users have multiple mobile devices, possibly used in different locations, the system also makes available a set of user mobile device IDs 138 and associated mobile numbers 136. It should be appreciated that FIG.2 provides only one arrangement of local database data and that other arrangements are also possible and fall within the scope of the present invention. Further, the data itself may not be static within particular areas of the database or static with respect to its data associations. For example, if one particular user's mobile device is transported outside its “home” geographical area, that buyer may wish that the product and service offerings needed within that geographical area also be presented on the “alternative” mobile device. Finally, while some of the user's preferences, such as an SMB, may have one or more specific geo-reference sites, other buyer product specifications, such as brand or product, have no such association. In this case, the buyer may desire to be matched with a specified brand or product in any of the geographic locations in which he or she is located. A geo-reference point 132 in combination with the user input list of SMBs, destination places, and brands as shown in section 134 is referred to as a preferred offering 133.

In one envisioned embodiment, the user controls all product selection criteria and will pick a preferred list of SMBs, destination places and brands from a master list. The master list is presented in menu fashion on the user interface which is necessarily associated with a physical location. These selections will constitute the user inputs and act as an alternative to the specifically selected values that are input by the user. As mentioned, the physical user location may be derived from any information the user inputs directly, examples of which include, but are not limited to, a parcel identifier, a geographic coordinate code (“Geocode”), a global positioning system (“GPS”) coordinate, a country, a state, a county, a district, a zip code, a street address, a street corner, a public location, and/or a public transportation location. This physical location information as input by the user is considered the geo-reference point of the user by the internet service provider. With respect to mobile users, the geo-reference point necessarily moves with the user.

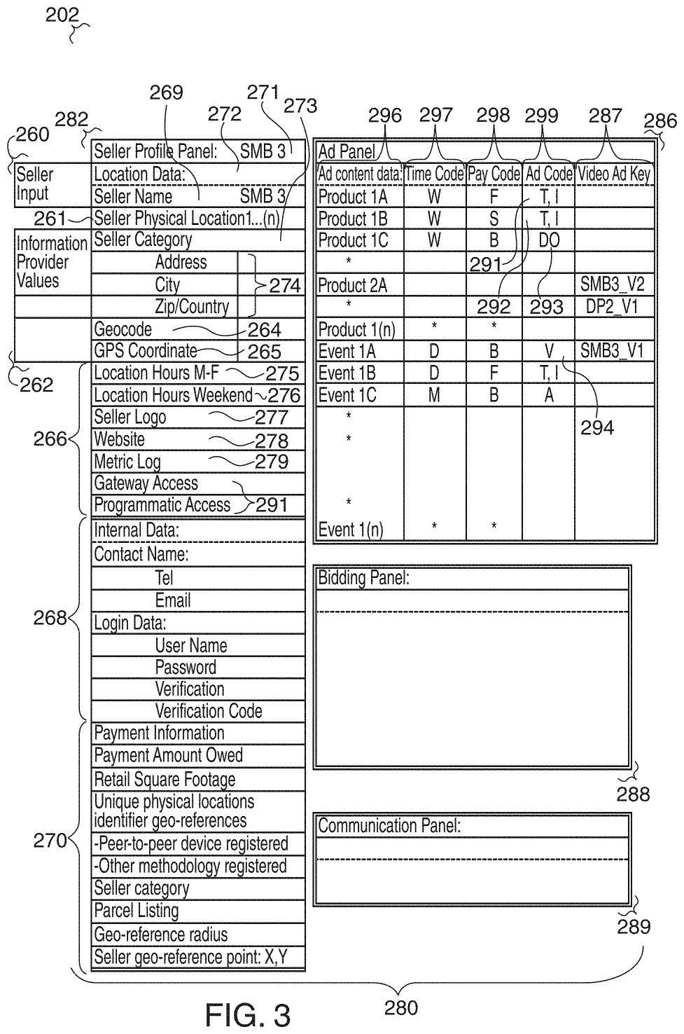

It should be noted that a geocode is a deterministic value that uniquely identifies a seller regardless of other location-based data. For example, GPS coordinates can be inexact as can street addresses. The geocode of the present invention uniquely identifies a particular seller in the context of this invention, and once determined, is input on the seller's profile panel at 264 of FIG. 3.

In another envisioned embodiment, the default list of vendors is conditioned by the mobile network and the ISPs which manage the information transmission to the potential buyers. In this model, the user may pick from a default list of SMBs, destination places, and brands associated with any geo-reference point input by the user. These entities are then screened and/or selected by the internet service provider 55 of FIG. 1. However, unlike the buyer-driven model, the ISP may screen the available default listings based on the inputs of a plurality of users 20 associated with the geo-reference of the physical location which the ISP then makes available through the mobile network 50 to all those users. These may even be selected on a bidding basis as described below. With respect to a user starting a new job, for example, it may difficult for the user to pick a definitive list of geo-references for immediate use. Therefore, it may be convenient to choose a default list of geo-references for immediate use, which that user may then alter as his familiarity with the geo-reference improves.

The flexibility of the user interface 130 enables the buyer 20 to add or delete SMBs, destination places and brands through navigation of the user interface. Further, various parsing and search modes may also be engaged within the interface, possibly with managed help provided by the ISP. The user can edit their user preferred list by adding, deleting, and storing individual SMBs, destination places and brands through the interface 30 utilizing these different methodologies at any time. Therefore, the user's repetitive interaction with his or her preferred content in combination with the constant updating and storing of relevant geo-centric lists, optionally as conditioned by the ISP, provides a rich buying experience and sales engagement potential for the user.

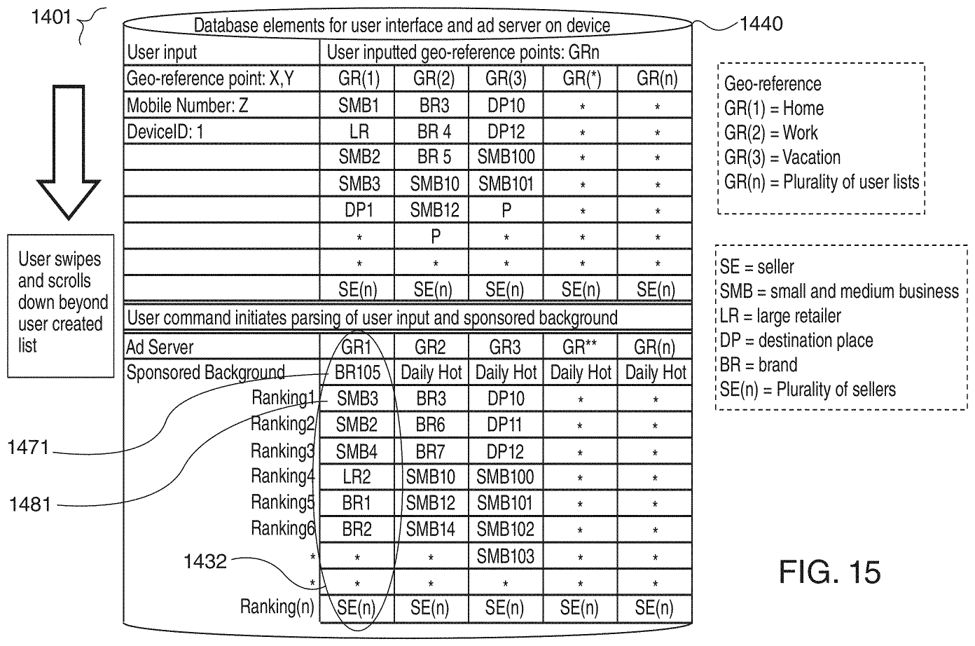

The ad server data found in database section 124 and managed by the ad server typically involves sponsored background advertisements and ranking of the same as described in more detail below. This portion of the user's local data base 140 is discussed in connection with FIG. 15 and in connection with the actual functioning of the sponsored background advertising. With respect to the user-input information in database section 130, the ad server acts to block or protect unique user identification data as it communicates with the network 50 and the ISP 55. Although the ISP and seller functions are described in more detail below, it should be emphasized and appreciated that the data having particular identifying capabilities with respect to the buyer, such as the mobile number and device IDs, are never transmitted to the seller. Instead, the ISP is the only entity that collects and retains this information and only for the purpose of establishing communications with the mobile devices on an as-needed basis. Depending on the default listings presented to the buyer, certain sellers may know only that a certain number of interested purchasers are proximate to their geo-reference. Based on this summary buyer information, sellers may condition their sales, promotions, and discounts appropriately, possible in connection with advanced advertising functions. These are also described in more detail below. It is this distinction, in combination with other aspects, which differentiates the present invention from other mobile advertising platforms designed and offered to-date.

FIG. 3 is a data diagram 202 that shows a data-centric view of the data stored within the seller's dashboard panel 280. The seller's dashboard panel is, in turn, composed of at least four different panels: the seller's profile panel 282, the ad panel 286, the bidding panel 288, and the communications panel 289. The seller's profile panel 282 enables the inputting and updating of seller profile information. Data section 260 is provided for seller input and consists of the unique seller ID information 271 (SMB3) used by the system of the present invention, location data 272 identifying the location of the seller, the seller's actual name 269, and the seller's one or more physical locations 261. Data section 262 is provided within the seller profile panel 282 to house the ISP transmitted information. This is envisioned to contain data that is important for the ISP to use to match the buyers and their geographic and sales preference information with the seller's goods and services offered for sale. Subsection 262 might include information such as a seller's identifying category 273, the seller's physical mailing address 274 including the street address the city and the zip code, the seller's actual geocode 264 (as uniquely used by the system of the present invention) and the GPS locations 265 corresponding to the physical locations provided in 261. Other seller information may include: the hours of operation at particular locations 275, the seller's weekend hours 276, the seller's logo 277, the seller's website URL 278, the seller's metric log 279, and ISP access information and credentials 291. This access information might include an internet gateway access address and other programmatic access for use by the seller to allow users to have access to its commercial information—e.g. to browse store contents or a restaurant's menu for example.

Geocoding as used in this invention, is a unique geographic tag used as part of the overall process of identifying a seller. It is the process of finding associated geographic coordinates (expressed as a singular site location or latitude and longitude) that uniquely identifies a seller. Geocodes may be derived from other geographic data, such as GPS coordinates, street addresses, or ZIP codes (postal codes). Geocodes are described in more detail below with respect to the operation of the present invention. Geocodes are unique as pertaining to a particular seller and within the overall geographic coordinates of the sales and advertisement system of the present invention.

In additional sections of the seller profile panel, information specific to the seller may be provide within data section 268. Included within this data section may be various internal seller data, a seller's contact name, telephone number, and email address. The seller may also wish to include various login data used to access the seller dashboard, such as the user name, password, verification codes and other verification information. Finally, the seller's profile panel may include other miscellaneous seller information 270 such as payment information, payment amount owed, retail square footage, unique physical location identifier, peer-to-peer registered devices, other device connection registration information, seller category, parcel listing, geo-reference radius within which the seller wishes to advertise the goods and services for sale, and the seller's geo-reference point X,Y with is the unique physical location corresponding to the sellers geocode.

The seller's dashboard 280 consists of programmable application functioning as a self-serve platform with primary functions that enable a seller to access, upload and transmit its corporate information, inventory information, and ad content associated with the seller including ongoing and upcoming sales and promotion cycles and the associated physical location for the same. The seller's dashboard 280 is envisioned to be accessed primarily through a mobile device such as a smart phone, tablet, wireless gadget, portable gadget, or portable personal computer, desktop computer, computer server, or smart television. The seller will use the dashboard to access all associated computer equipment, devices and display screens. In the brick-and-mortar world of actual store frontage, the seller traditionally places notices, specials, and advertisements on in front of their physical store location(s) to capture attention and draw foot traffic into their store from the existing, external pedestrian and vehicular traffic outside their physical store. In one particularly preferred embodiment of the present invention, sellers are able to create and access a seller account within data section 286 to input their specific ad content. This is provided for in the ad panel 286 in which the seller is capable of inputting and updating of seller ad content. Within ad panel 286, there are several associated columns of information. For each product to be listed in a mobile advertisement 291-293, the following relevant data is included: content of the ad data 296, and a time code 297 indicating when the ad should be displayed (e.g. W for the week of the year in which the ad should be run). The seller may also associate each item of the seller ad content with a pay code 298 input by the seller. These pay codes would be used by the information provider to determine how that ad content would be positioned within the mobile device display depending on the user preference and setting. These pay codes may include but are not limited to nonpayment (F=free), subscription (S=recurring payment), and bidding (B=bid for ad priority within user interface). Actual prices quoted to the mobile network from the ad panel may be static or they may vary considerably based on any of a number of factors. In one highly dynamic pricing structure, the amount quoted for an item is derived by the ad panel as based on a combination of time code, ad code, and pay code attributed to each item. Finally, the ad code 299 is provided for each advertised good to identify the formatted nature of the advertisement, e.g. data object (DO), text (T), image (I), audio (A), and video (V). These formats may be tied to the to various payment options for each element of the ad content within the dashboard given the precious nature of the bandwidth restrictions on the overall mobile advertising system.

Two other data areas are included as part of the seller dashboard 280. First, the bidding panel 288 is provided and serves to enables the ranking and inclusion of a seller's ad content for distribution throughout the system 10 and display within the ad sponsored background on the user interface and ad server of the plurality of system mobile devices. This is described in more detail later in connection with FIG. 15. The communications panel 289 enables the user to communicate with and share data with the seller and also serves to enables the seller to communicate and share with the information provider. The communication panel may include real-time communication interfaces, such as a simple text box, electronic suggestion box, email box, etc. to facilitate communications between buyers and sellers.

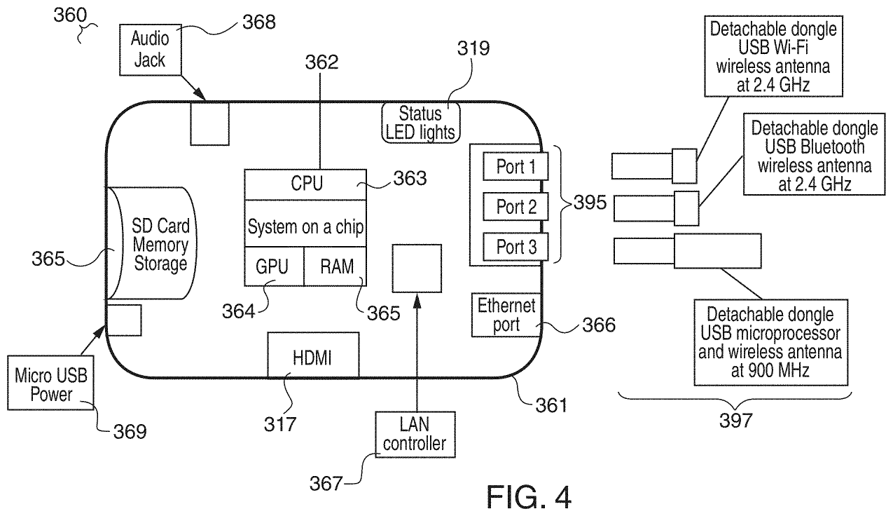

FIG. 4, illustrates a block diagram of a physical location device 360. The physical location device is resident at a physical seller location and acts as a distribution point for a seller's ad content as well as possibly providing a networked wireless connection node to mobile devices 12 as they traverse the seller's establishment or its proximity. This physical location device will typically be a small-sized, low-power computer (or system on a chip) 362, located on a single circuit board 361, utilizing a system on a chip comprising at least of a central processing unit (“CPU”) 363, a graphics processing unit (“GPU”) 364, and one or more memories including random access memory (“RAM”) 365. Circuit board 361 may include a LAN controller 367 and associated Ethernet port 366, an ultra-small flash memory card slot (“SD Card slot”) 365, audio jack 368, a micro-USB power adapter 369, high-definition multimedia interface (“HDMI”) 317, and status-oriented light-emitting diodes (“LED”) 319.

A series of USB ports 395 are also included on physical location device 360. These ports are to accommodate various circuit board input/output (“I/O”) functions. Removable, wireless or radio frequency USB dongles 397 may be inserted into USB ports 395 to complete the communications architecture. Each dongle typically also includes its own microprocessor as well as, a wireless radio transmitter and an antenna. In operation, the computers on the dongles, in connection with the programs within the system on a chip 362, run programmable application software application that operate to wirelessly transmit a seller's unique physical location identifier. This wireless signal is used to communicate with other nearby devices, remote hub devices, wireless routers, smart TVs and user mobile devices using Transmission Control Protocol (“TCP”) and the Internet Protocol (“IP”) via wireless Wi-Fi, Bluetooth, or other unlicensed spectrum such as within the 900 MHz spectrum band. Much like the vendor advertisement chalkboards found on street sidewalks, the physical location device is located at the seller physical location and may be attached to a front window, front door, or point of sale counter utilizing screws, tape or Velcro fasteners.

As with all other programming described herein, the programmable software application running on the wireless dongles 397 and the system on a chip 362 will typically be developed with a suitable programmable language, such as, but not limited to, object-oriented languages, C, C++ and/or Java. Through this software, the seller's physical location device serves as a two-way transmitter using low data bandwidths in both licensed and/or unlicensed spectrum space. The programmable software application's primary function is to enable communication with a user device at the seller physical location thus enabling the physical location device to transmit an identifying code to uniquely identify and correlate the seller to the user preference list. Further, the physical location device 360 and its wireless connections provide user devices 12 to access more of the data within the seller dashboard 80—certainly more data than that provided through the wireless ad content distributed by the overall advertisement system 10. For example, full weekly circulars, the entire store inventory, and price list of the seller may be made available to the user's mobile devices 12 through this interface when the buyer is near the seller's geo-reference.

In combination with other proximate physical location devices, the programmable software application operating on the dongles 397 and circuit board 361 may specify higher level network and communication protocols to communicate with other seller's physical location devices within the wireless transmission capabilities of the wireless transmitters and antennae. In this manner, a wireless, ad-based antennae array may be created, particularly within crowded commercial areas such as major metropolitan streets or large indoor commercial establishments such as a mall. Although the physical location device is envisioned to be relatively low-powered in its transmission capability, any one antenna may transmit data over long distances by passing data through other connected physical location devices to reach more remote physical location devices without wireless or wired broadband service provider access to the internet. The data transmission requirements of these physical location devices are expected to provide a transmission range from 10 feet to 100 meters in a line-of-sight fashion, depending on one or more of the antenna power outputs, wireless frequency band used, local geography and environmental characteristics. The data transmission rates may vary from 1 megabit per second (“Mb/s”) in the 900 MHz frequency band to 150 Mb/s in the 2.4 GHz frequency band.

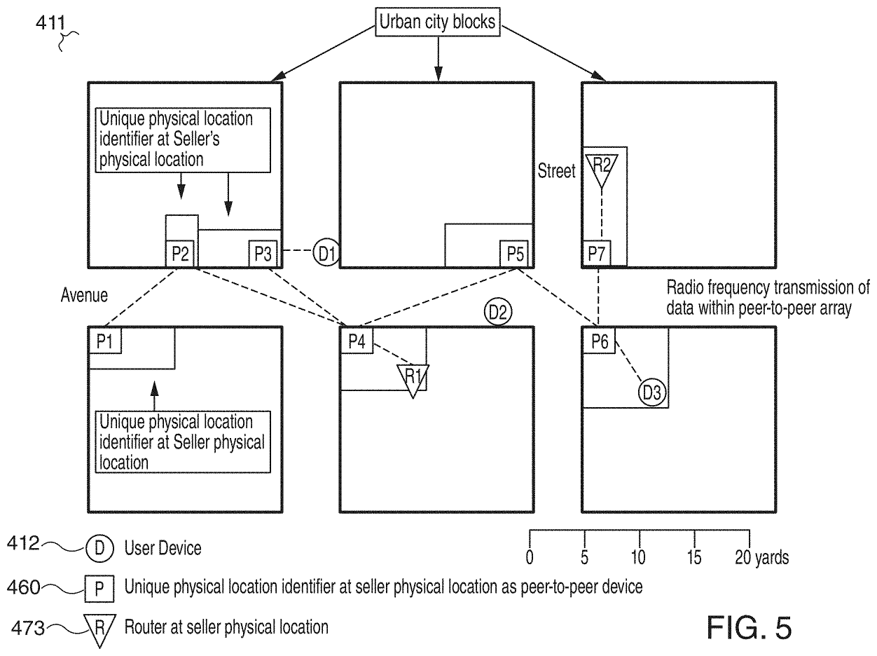

FIG. 5 illustrates a spatial, geographic and data flow diagram 411 providing examples of some of the peer-to-peer networking functions available to the array created by a plurality of the physical location devices. Physical location devices 460 P1-P6 are situated at respective seller physical locations along an avenue of city blocks, shown as streets between buildings in FIG. 5. Data may be synchronized between physical location devices regardless of the internet connection provided to any of the devices. D1-D3 represent unique user devices 412 within the peer-to-peer, ad-centric wireless network. R1 and R2 are wireless Wi-Fi routers 473 operating at seller's physical locations and which have access to the internet through commercial broadband and cellular data providers.

As shown in FIG. 5, physical location devices P4 and P7 are peer-to-peer networked devices that have internet access at the sellers' physical locations through routers R1 and R2 respectively. Physical location devices P1, P2, P3, P5, and P6 do not have commercially provided internet access at their respective sellers' physical locations. P1, P2, P3 are able to pass through data transmissions to P4 and receive data transmissions from P4 which has internet access through the R1 wireless Wi-Fi router. Therefore P1, P2, P3, and P4, coordinating as an array of seller peer-to-peer networked physical location devices, enable each of the physical location devices of the invention to coordinate data, provide the mobile devices 412 with advertisement-based data, and provides general low-bandwidth access the internet through connected ISPs. Likewise, P5 and P6 are able to pass through data transmissions to P7 and receive data transmissions from P7 which has internet access through wireless Wi-Fi router R2. Using this technique and enabled by the programmable software applications on the wireless dongles and the physical location devices, these physical location devices may now transmit data over longer distances than those enabled by the limited wireless router transmission capabilities and further include devices that have no commercially-serviced network access.

With respect to the operation of user devices, user device D1 is communicating from outside of the seller's physical location which has physical location device P3 displayed on the seller's storefront window. In this example, the user interface on D1 allows the user to add the seller represented by the unique physical location identifier from P3 to the user's targeted list of sellers on the user device and as specified by the seller's geo-reference point. The D1 user interface determines the quality of the data transmission from P3 and decides whether to request ad content from P3 or determine a better quality of data transmission when available, to request the ad content from the information provider.

Before the operation of the invention is described with reference to a specific geographical context, it is instructive to discuss the buyer and seller inputs and data flows provided by system 10. As stated, a primary object of the invention is to maintain a buyer's privacy while somehow matching buying preferences to sellers' offerings. Likewise, the relevant sales information and ad specific content of the seller is to be provided to the appropriate buyers. All of this is done with reference to the geographic proximity of the buyer and seller and possibly in the context of temporally conditioned advertising. Therefore, the end goal is to establish a simple, geo-centric, and possibly time-based, association between a buyer's geo-reference point and seller geo-reference point in which the buyer's preferences are matched with the seller's offerings at a mutually convenient time so as to effectuate the ad distribution and complete a resultant sale.

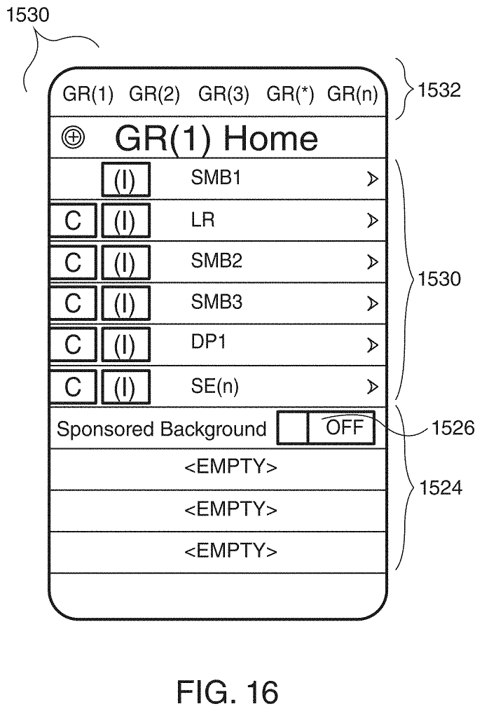

One of the novel aspects of the present invention is the function and location of the buyer's ad server 24. Unlike many of the presently operating business models for commercial advertisement distribution, and the inventions pertaining to the same, the buyer's ad server is on the actual user device 22. It is not part of the seller's ad distribution system, nor are any of the management elements on the mobile network 50 or housed within the ISP's cloud structure 57 and associated hardware and software. The ad server manages all of the specific buyer's preferences, geographic areas of interest and displayed content. The entire management process is user-driven and programmatically selectable by the user. Descriptions regarding the actual mobile device displays are provided infra with respect to the discussion of FIGS. 16-20.

The mobile network's role in this process is to maintain the anonymity of the buyer, match geographic information of the respective buyer-seller pairs, match preference and advertising information of the respective buyer-seller pairs and push the sellers' advertising content to the buyer's mobile device 22 to be displayed on its UI 30. What the buyer does with it from there is up to the ad server 24 on the buyer's device as conditioned by the buyer's preferences as executed through user interface 30 on mobile device 22.

As discussed in part above, the buyer's preferences as entered into user interface 30 and mobile device 22 drive the overall purchase decisions and shipping process. Geographic locations 132 of interest are identified and added by the user. These may simply be input by the buyer, added while walking about, or selected from a map. These geographic locations may be transcribed to geocodes as required by the implementation of the system 10. The buyer then inputs sellers of interest, user-targeted lists of SMB s, destination places and brands 134 of interest. These may be individually entered or made available from a prefabricated menu structure or drop-down boxes presented to the user. Deletion of a seller, product or destination place likewise results in the disassociation of a particular buyer's geocode GR(n) from the user's mobile device. In this manner, and as shown in FIG. 2, one particularly preferred organization of the purchase preference data is a geocentric one, i.e. one in which the index is the geographic identification of a location in which the buyer frequently finds himself or herself, and/or in which he or she is somehow interested in managing a purchasing decision. Those of skill in the art may appreciate that other forms of data organization and association, including the use of alternative data groups and indices, may also be used to achieve similar ends. The geocentric model of purchasing, however, is one of the more natural paradigms for mobile devices, mobile buyers, and sometimes even mobile sellers, since co-location of the buyer and seller are necessary for a real-world purchase. Notwithstanding differences in possible data organization, the teachings of the present invention may also be used to for forecast sales in which a buyer (or seller) intends to be in a particular geographic location in the future but wishes to have knowledge of or evaluate the purchasing decisions and shopping opportunity beforehand.

Again, the user device becomes a useful reservoir of purchasing opportunities when the buyer is physically present within a selected geographic area of interest. As a user configurable option, advertising material may be continuously pushed by the network to the mobile device on a real-time basis at all times or only when a user is within the particular geographic area of interested and is open to purchasing opportunities or temporal intervals matching seller interval cycles. The former might be useful to plan a travel itinerary for a day out of shopping. The latter may be useful during a working day in which only possible locations for good deals on bread, milk and toiletries are desired. As mentioned, an ad server on the buyer's device, under the control of the buyer, is the ultimate arbitrator of the information conveyed to the buyer.

From a seller's perspective, the following information flow occurs. The physical location of seller is derived from information the seller 70 inputs to the seller profile panel 82. This can be derived from one or more of the following data elements input into that panel including: parcel listing, geographic coordinate code (“Geocode”), global positioning system (“GPS”) coordinate, country, state, county, district, zip code, or street address. A parcel listing is associated with real estate tax systems and can also include national, state, and county managed real estate property. The physical location information input by the seller is provided to the information provider 55 within the mobile network 50 and is verified by the information provider through on-site verification and/or third-party verification services. A seller geo-reference point pertains to a seller's single physical location. A seller account can register and maintain a plurality of seller physical locations 261 within the seller profile panel 282, each with a seller physical location associated with a unique geo-reference point. A seller account can further specify a physical geographic boundary or radius from its geo-reference point (shown within 270 of FIG. 3) within which the seller is interested in delivering content to buyers that have flagged a geocode within that geographic boundary.

In operation, the seller transmits its ad content to the ISP 55 directly from the ad panel. Such information would conceivably include product sales details, associated time-based sales offers and ads, and any specialized price computations made by the ad panel based on the information therein. The internet service provider then performs the above-described matching functions for buyers and pushes the advertising content appropriately.

On a more local level, it should be appreciated that the above-described peer-to-peer network may also be used without the assistance of the internet service provider to disseminate the same information. When using the peer-to-peer network, the data transmission and availability may be broader than that provided through the ISP, particularly when the network detects that an interested buyer is geo-located within a range of the seller's location. Nevertheless, the identity of any particular buyer is privately maintained since the information flow is nothing more than site location of the buyer, interested seller identification and data transfer to the buyer's mobile device.

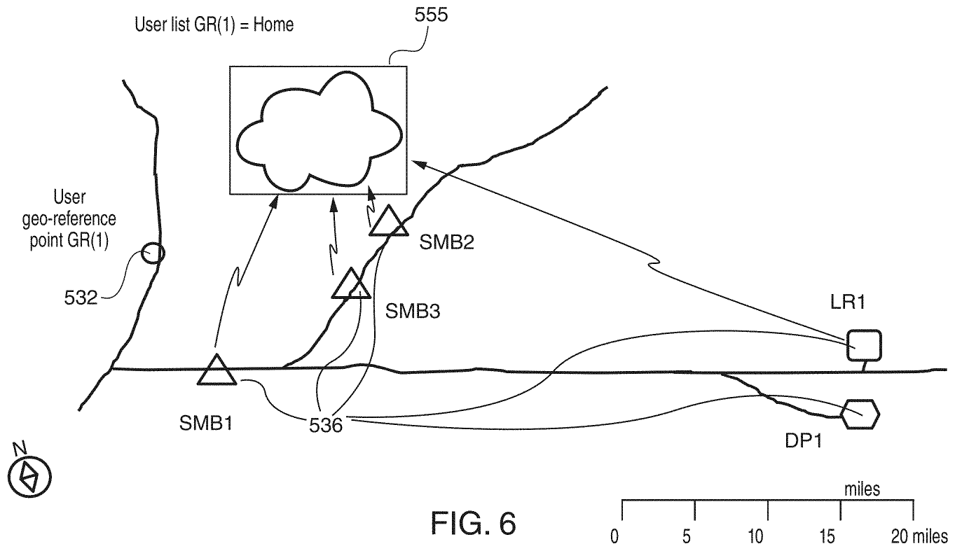

FIGS. 6-12 provide a series of geographic representation of the operation of the present invention according to several preferred embodiments.

As shown in its most fundamental depiction, FIG. 6 shows a user-selected geo-reference point GR(1) 532 that has been flagged as a point of interest by the buyer. In this example, GR(1) pertains to a home location of the buyer. The user's selected or physically determined location GR(1) is known to the internet service provider 555 by virtue of its data connection to the same. Given this, the user-created target lists of sellers that are within a certain distance of the buyer's geo-reference point of interest are pushed to the buyer's mobile device based on the previously input user information and are displayed in map format thereon. In this manner, geo-centric associations between the user input geo-reference point GR(1) and a plurality of sellers 536 identified by their geo-reference points SMB1, SMB2, SMB3, LR1 and DP1 is made by the overall advertising system. In the particular example of FIG. 6, the distance scale is shown as parsed in 5-mile increments. Presuming that the buyer is present within or proximate to his or her geo-reference point GR(1), subsequent visitation of any of the sellers on the buyer's list would most likely require the buyer to drive a motor vehicle in order to reach any of the seller's physical locations. Thus, the physical, real-world variables of time management, convenience and price of gasoline will be some of the considerations taken into account by the user in selecting sellers that are to be visited as part of the sales experience. Again, with the assistance of the internet service provider, the buyer is enabled by the user interface on the mobile device to track the user-derived list of seller physical locations and determine the availability of specified products or brands of interest, while also being provided relatively instant access to which of the proximate sellers are running promotions and any associated timing elements of the same.

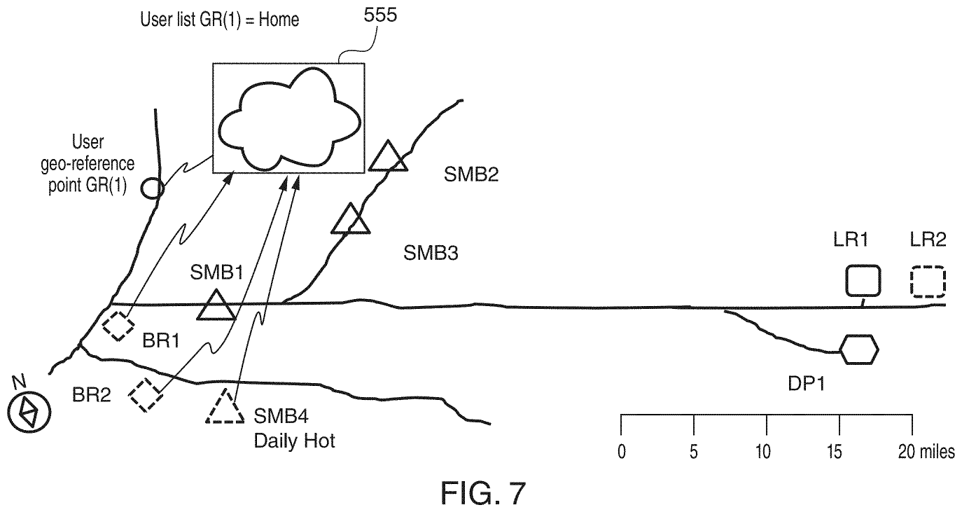

FIG. 7 shows a variation of FIG. 6 in which individual brands BR1 and BR2 identified as being of interest to the buyer are also pushed by the internet service provider to the buyer based on geo-location GR(1). This may in fact be a configurable option on the buyer's mobile device. For, example, the user interface may provide the buyer the option to be made aware of sales that pertain to certain brands regardless of the inclusion of a seller within the user profile or the buyer's actual geo-location. Further, additional sellers SMB4 and LR2 of those brands may also be presented to the buyer if so configured on the mobile device and desired by the buyer.

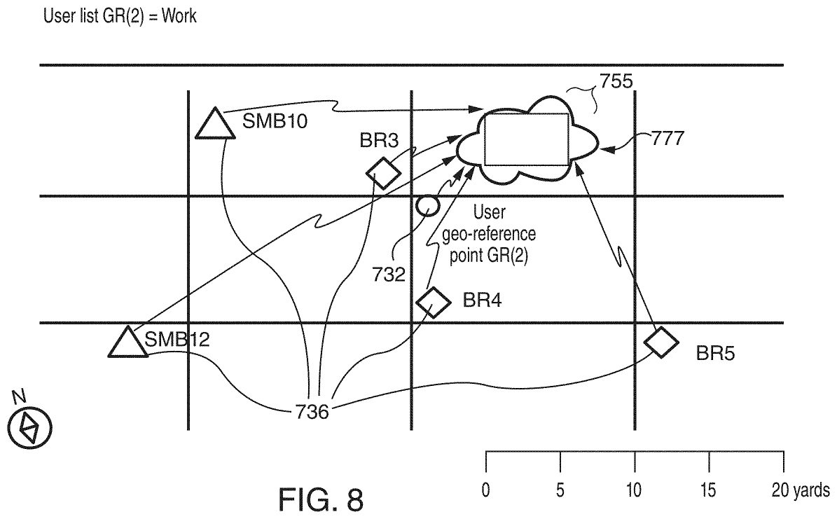

FIG. 8 shows an urban variation of the geographic representation presented in FIG. 6. In this environment, a different geo-locator GR(2) 732 is selected within the user profile as being the preferred geocode for ad distribution. This particular geo-location reflects the buyer's work location. As with FIG. 6, the user's selected or physically determined location GR(2) is known to the internet service provider 755 by virtue of its data connection to cloud 777 and associated mobile network containing the same. Given this, the user-created target lists of sellers that are within a certain distance of the buyer's geo-reference point of interest are pushed to the buyer's mobile device based on the previously input user information and are displayed in map format thereon. In this manner, geo-centric associations between the user input geo-reference point GR(2) and a plurality of sellers and brands of interest 736 identified by their geo-reference points SMB10, SMB12, BR3, BR4 and BR5 is made by the overall advertising system. In the particular example of FIG. 7, the distance scale is shown as parsed in 5-yard increments. Presuming that the buyer is present within or proximate to his or her geo-reference point GR(2), the buyer is likely to be able to walk in order to reach any of the seller's or brands so as to show physical locations. Again, with the assistance of the internet service provider, the buyer is enabled by the user interface on the mobile device to track the user-derived list of seller and brand physical locations to determine the availability of specified products or brands of interest, while also being provided relatively instant access to which of the proximate sellers are running promotions along with any associated timing elements of the same.

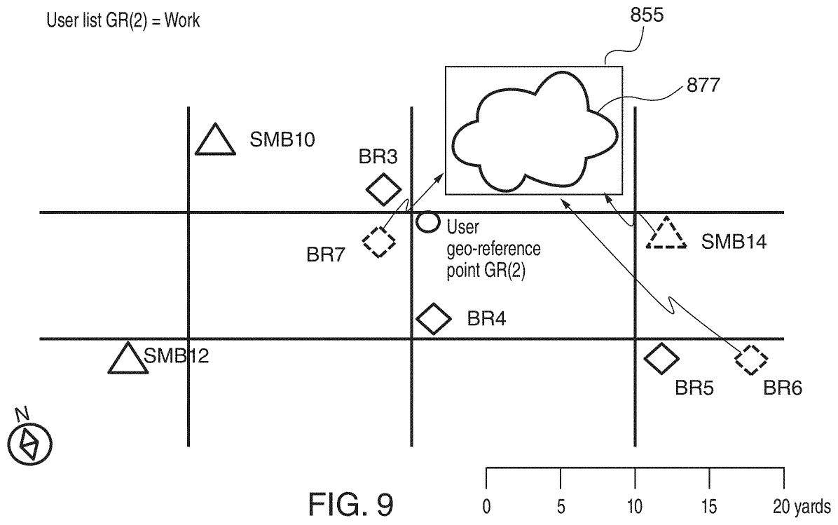

FIG. 9 shows a variation of FIG. 7 in the urban context described above with respect to FIG. 8. Here, individual brands BR6 and BR7, which are identified as being of interest to the buyer, are pushed by the internet service provider to the buyer based on the buyer's geo-location GR(2). Such buyer brand notifications, i.e. irrespective of the buyer's specification of sellers, may in fact be a configurable option on the buyer's mobile device. For, example, the buyer's user interface may provide the buyer the option to be made aware of sales pertaining to certain brands regardless of the sellers within the user profile or the buyer's actual geo-location. Further, additional seller SMB14 of those brands may also be presented to the buyer if so configured on the mobile device and desired by the buyer.

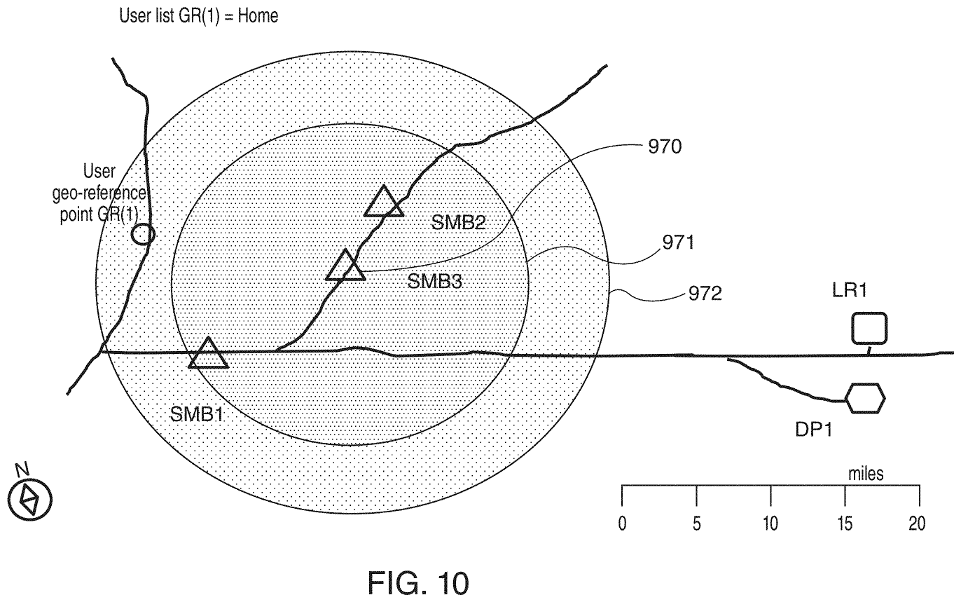

In FIGS. 6-9, the selection of the displayed sellers, brands, products and destinations on the buyer's mobile device were based on a physical distance measurement selected by the buyer and as determined by the internet service provider and its GPS determining apparatus 52. As with all data and display characteristics of the present invention, the buyer's input governs the ad system's operation and resultant display of relevant data. Certain other methods of displaying ad content on a buyer's mobile device may be considered, however. In these methods, the seller plays a more active role in determining the goods and services transmitted to the buyers for ad display. This is particularly applicable when the seller has limited inventory or wants to tease buyers to make purchases based on highly local sales advertising. One such system and method of seller conditioning is provided in FIG. 10.

FIG. 10 shows an alternative embodiment to the geographic layout of FIG. 6. As an adjunct to the system described in connection with FIG. 6, the seller may take a geo-centric view of the ads to be delivered. When the buyer's preferences for distance from the buyer's geocentric location match that of the seller, in combination with a match of buyer's preference for sellers, products, brands and/or destinations, a match is declared by the internet service provider and the seller's ads are transmitted to the buyer. Specifically, in the example of FIG. 10, the seller may select a radius about its geo-reference point and within which it wishes to circulate its ads provided that the seller and/or its goods and brands is on the respective buyer's lists. This radial data element is shown in the seller profile panel as the “geo-reference radius” within data section 270 of FIG. 3. As shown in FIG. 10, seller SMB3 is shown at the epicenter of the inner radial circle, and therefore, is the one entity taken into consideration as part of the overall ad distribution. Each seller may, of course set its own ad distribution radius. FIG. 10 is provided in simplified form, however, to depict only one such seller configuration.

Again, with respect to the seller-specified ad distribution radius, this parameter may be input by the seller as a static value, or it may have dynamic components based on various criteria selected by the seller. In one dynamic-based embodiment, the radius is determined by the internet service provider utilizing algorithms based on the seller category 273 and possibly the total number of users identified as having a geo-centric association with the seller within the circles. The seller may in fact be interested in expanding the radius if the number of sellers is over a certain threshold since the probability of creating larger numbers of geo-centric associations is greater. This ad to be disclosed and the buyers to whom they are distributed is determined by the internet service provider since that entity would have all the buyer's profile information, as it pertains to sellers of interest, at its disposal. A seller may additionally specify additional radii having different circumferences so as to accommodate weather, topography, a seller category 273 and the total number of interested buyers within either of the two radii. A seller may start with one radius of interest 971 and depending on the above criteria and the response of the buyers to the ad distribution, the seller may increase that radius to the second level 972 to attract more customers. Additionally, these radii may have time-based components that affect the display of the seller's ads on the buyer's mobile devices. Depending on the locations of the respective buyers within those radii and their respective distance parameters, the buyers will receive the sales and ad notifications from the seller.

Certain other methods of conditioning the distribution of ad content may be considered, however, particularly when the buyer's preferences indicate a particular brand or product. Since brands and products do not have a geo-centric presence apart from their sellers, numerous alternative methods of notifying buyers of the availability of these preferences may be employed. One such system and method is through the use of the seller's bidding panel 88 on the seller dashboard 80.

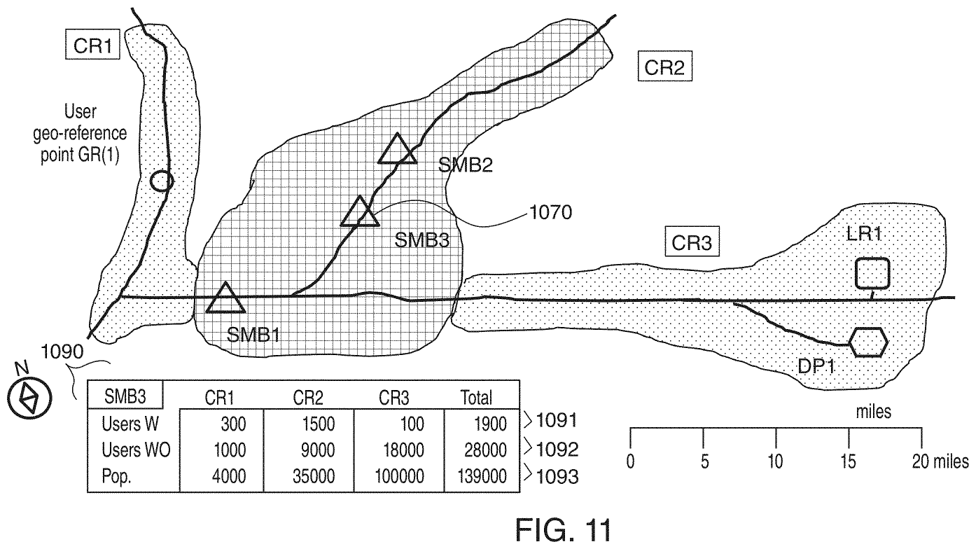

FIG. 11 shows yet another alternative embodiment of the geographic layout of the sellers provided in FIG. 6. However, this graphical depiction is intended to provide sellers with useful marketing information in connection with the present invention. As shown, the geography of FIG. 6 has been segregated into three separate geographic areas CR1, CR2 and CR3. Each of these three areas represent distinct areas in which a seller may be interested in bidding for advertising placement and may compete with other sellers for such placement. Geographic areas are shown as having irregular boundaries and correspond primarily with population centers with CR1 being more rural, CR2 being suburban, and CR3 denoting a more urban area. The seller of interest SMB3 1070 is located in CR2. Chart 1090 shows data corresponding to the three areas and in which seller 1070 may take note in making ad purchase decisions. Chart 1090 shows the three areas as indexed against three population groups. At row 1091 (“W”), the number of mobile users having a geo-association with SMB3 are shown within each of the geographic areas and also as a total for the sum of the areas. More particularly, row 1091 (“W”) shows the number of mobile device users of the present advertising system that have SMB3 designated as a preferred seller on their mobile devices. At row 1092 (“WO”), the number of mobile users on the advertising system that do not have a geo-association with SMB3 are shown within each of the geographic areas and also as a total for the sum of the areas. Finally, at row 1093 (Pop.), the total population for each of the geographic areas is provided including the sum of all the areas. The internet service provider(s) handling the three geographic regions would be able to determine and provide access to the user counts for rows 1091 (W) and 1092 (WO) by virtue of the system-wide data that the ISPs have on all mobile data users within its service coverage areas. The total population numbers for CR1, CR2 and CR3 would likely be provided by public and private sources such as the U.S. Consensus Bureau and third-party demographic providers.

An examination of the population data within chart 1090 shows the following: CR2 contains the greatest number of system subscribers (1500) that have a geo-association with seller SMB3. This is not surprising given that CR2 is the “home” geo-position of the seller. CR3 is also shown as having the largest population (100,000) as well as the largest number of ad system users (18,000). Therefore, SMB3 must make a trade off in making its marketing decisions: advertise to a smaller group of system users where the advertising penetration is greater as a percentage of system users, or bid for advertising placement in areas (e.g. CR3) in which the sellers advertising penetration is smaller on a population percentage basis. All sellers would benefit greatly from such information, and the system of the present invention may be configured to make this readily available to participating sellers.

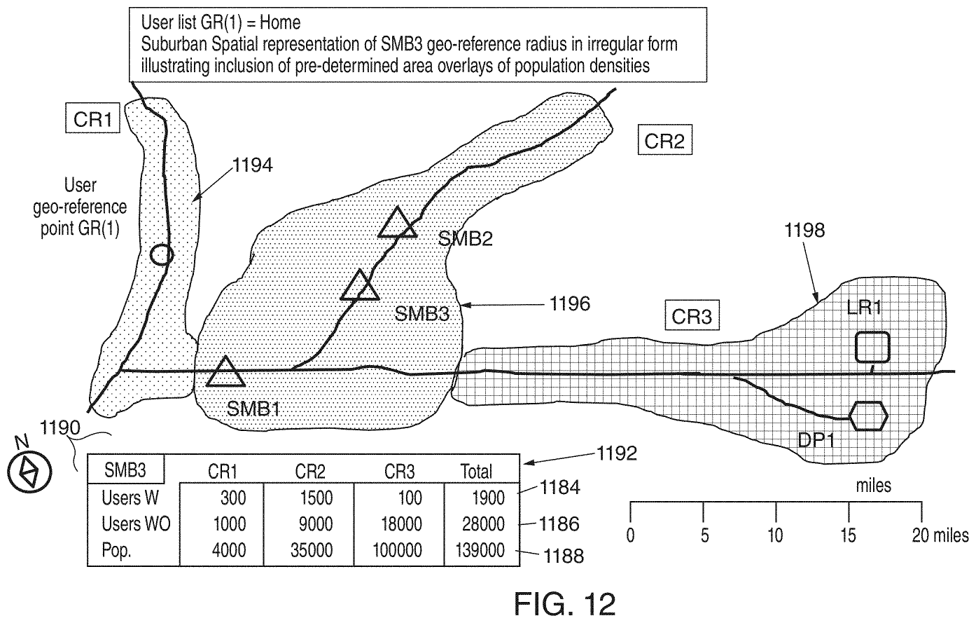

It should be appreciated that other indicia may be included in connection with the data provided within chart 1090, even if the accompanying data is not subject to easy collection by the ISPs within the system of the present invention. Foot traffic or vehicular traffic may be additional criteria that influences the marketing decision-making of SMB3. If the majority of the population of CR3 is pedestrian and their geo-associations are geographically tight as between the buyers' geo-locations and the sellers' geo-locations, then SMB3 may find that advertising within CR3 provides little cross-border shopping migration. These overall statistics would be easily determined by the ISPs and made available to the sellers to assist with their marketing (most likely provided at additional cost as well). Geographic maps such as those provided in FIGS. 11 and 12 might also be made available to sellers for such purposes. Using the density of the cross hatching as an indicia of density, the differences between the FIGS. is apparent. In FIG. 11 the geographic mapped density reflects marketing penetration, which reveals that SMB3 has the greatest geo-association penetration in CR2 (its “home area”) and the next greatest penetration in CR1—a rural adjacent area. In FIG. 12 where the marketing data 1190 is identical, the hatch density reflects inverse marketing penetration. FIG. 12 reveals that SMB3 has the greatest potential market penetration (all other factors being disregarded) in CR3 and the least marketing potential in CR1 where it has the greatest marketing penetration as a percentage of the total population.

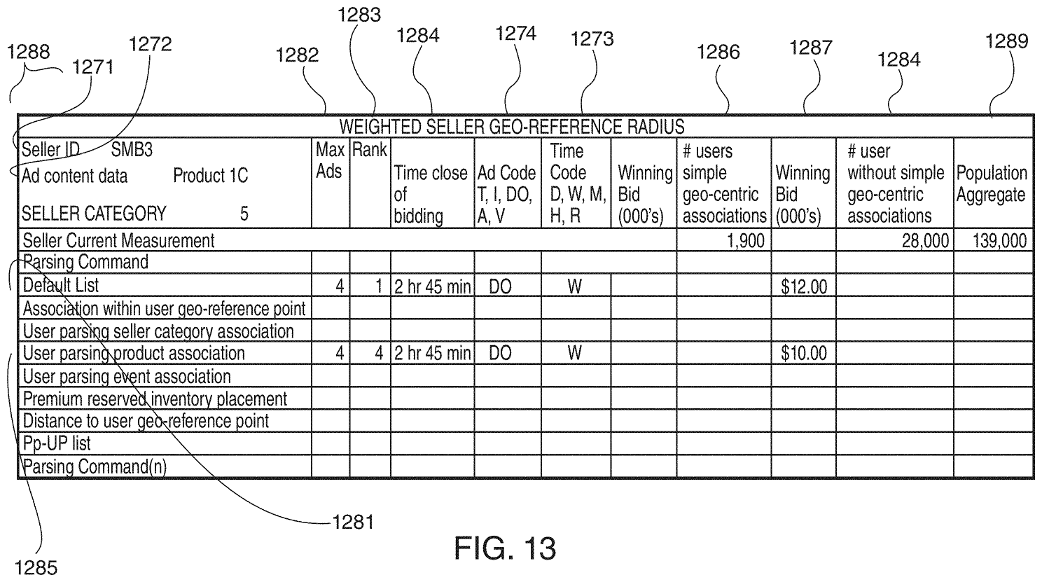

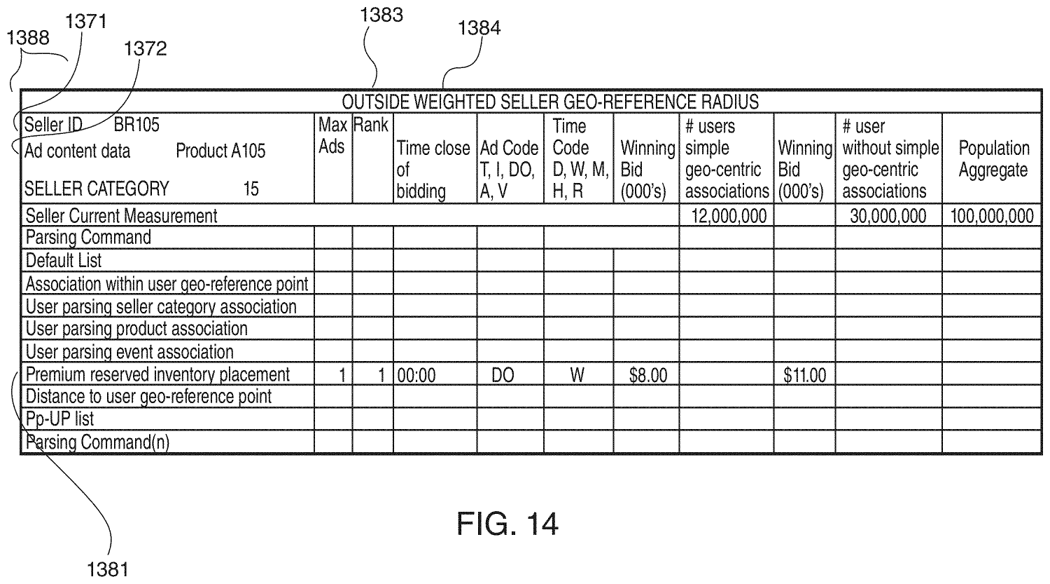

FIGS. 13-14 provide a working example of the bidding panels 1288 used by sellers 70 to make advertisement placement bids, particularly in the context of placing ads for brands and products specified by the user interface. FIG. 15 shows the resultant advertising data that is presented within the sponsored background section managed by the mobile device ad server 124 of FIG. 2. FIGS. 16-20 then proceed to show the corresponding mobile device displays that are created as the bidding process is executed.

FIG. 13 shows a bidding panel 1288 within which a seller may make bids for ad placement. As shown in FIG. 3, the bidding panel is part of the seller dashboard 80. The seller id (or geocode) is shown as SMB3 at 1271. The product on which the bidding is being conducted is shown as ad content data element “Product 1C.” The product identification (1C) is a designation provided by the seller SMB3 and is unique to that seller. Other sellers of the same or similar products may have different designations.

Current bids being conducted by the seller are shown as rows and identified by their appropriate bid label. There are two running bids shown in bidding panel 1288: a bid for listing SMB3 and product 1C on the default list 1281 and a bid for listing SMB3 and product 1C in a user parsing (search) list 1285. As mentioned above, the mobile device user may select default criteria for his or her user preferences absent specific identification of sellers, destinations, products, and brands. The bid for the search pertains to the displayed results when a mobile device user conducts a mobile search, for example, for a product that is in their preferred list. The winner of the bid gets the ad placement at the top of the respective bid lists.

Provided within the bidding panel fields, shown at the across the top of the bidding panel 1288 are the maximum number of ads being taken for the bid and display 1282, the bidders rank with respect to the running bid 1283, and the bid time remaining 1284. In addition, the number of geocentric associations with the bid product is provided 1286, the bid price (per thousand advertisements) 1287, the number of users without geo-centric associations 1284 and the total targetable population 1289 (assuming everyone had a mobile device and is present on the system). The bidding seller places his bid in the bid field 1287—shown as $12.00 per thousand for the default list. SMB3 is shown in column 1283 ad the first ranked bidder with this bid and is likely to get the top of the four open spots 1282 if bidding closes without a higher bid placed by another seller. If SMB3 wins the bid for the default list for product 1C then he will pay $36 dollars ($12×28(000)) active users. Note that the bid is per thousand potential users, even though not every buyer has product 1C as a preference. The winning bidder pays to have the ad placed with all system users even though a much likely smaller percentage of those users (1900) shown at 1286 have the higher probability of reacting to the ad placement since they are actively looking to purchase the product. In the end, the winner is bidding for all the devices within the georadius (1900+28,000) as determined by the database manager. Ad codes 1274 pertaining to the type of ad placement to be made (A-audio, V-visual, T-textual) are also shown in the bidding panel 1288 along with a time code 1273 indicating a duration of the ad placement. These factors are also necessarily considered by sellers when placing their bids in 1287.

FIG. 14 illustrates another bidding panel 1388 with a premium reserved inventory placement bid 1381 being conducted by BR105 (a brand name) for product A105. Premium reserved inventory placement would conceivably pertain to big box retail establishments such as a Home Depot or a Sears. From the bidding panel, it is clear that the bidding is over 1384, BR105 has won the bid 1383 and that the winning bid for the 12 million geo-centric users is $8—making the ad payment due for this portion $96,000. Further, BR105 also had the winning bid for regional ad distribution with a winning bid of $11 for 30 million placements—making the ad payment due for this portion $330,000.

FIG. 15 shows a more complete version of the data stored within the buyer's mobile device 22 in which the user designated sponsored ad button is “ON” and as compared to data diagram 101 of FIG.2. As provided in data diagram 1401 which contains the same data entered by the user of FIG. 2, the results of the bidding process illustrated in FIGS. 13 and 14 are displayed. Assuming that the user 22 was interested in geo-location GR(1) 1432 when the bidding took place, then the result of the bidding from SMB3 FIG. 13 is shown at 1481 as having SMB3 ranked #1 for ad placement. Since SMB3 is on the buyers preferred list, the buyer receives ads from SMB3 anyway as a result of user selection. It is only through the bidding process that SMB3 is ranked at the top of the displayed list of retailers within GR(1) when in response to a particular search for goods using the user interface. The products and goods actually displayed to the user through the user interface 1530 of FIG. 16, including the product 1C, are provided in the displays shown in FIGS. 16-20. The data ranking is the same for the bid won by BR105 illustrated in FIG. 14. Since BR105 won the bid for premium reserve inventory placement, then BR105 shows up at the premium ad placement location within the database 1401 at 1471 since the seller SMB3 is at least one SMB that offers the product. As stated above, the ad server 24 on the buyer's mobile device filters, coordinates and prepares the database entries within local database 1440 for visual presentation via the user interface 1530 of FIG. 16.

FIG. 16 provides a view of the user interface 1530 presented to the buyer on the user interface on the mobile device. The user-selected geo-references GR(1)-GR(n) are shown and displayed in a top portion 1532 called the geo-reference selection bar. Using the touch-screen capabilities of the mobile device, a desired geo-reference within the buyer's list may be presented in full (sections 1530 and 1524), in the display below the geo-reference selection bar. In the example of FIG. 16, GR(1)—HOME has been selected for display. User input data 134 of FIG. 2, such as user preferences for sellers, products and locations, is shown within display section 1530. With the sponsored background slider button 1526 set to the off position, the ad server does not manage the presentation of any sponsored (bid on) advertisements. Therefore, this display area 1524 is displayed as empty and is not functionally relevant to the operation of the mobile device as described in connection with FIGS. 1-12.

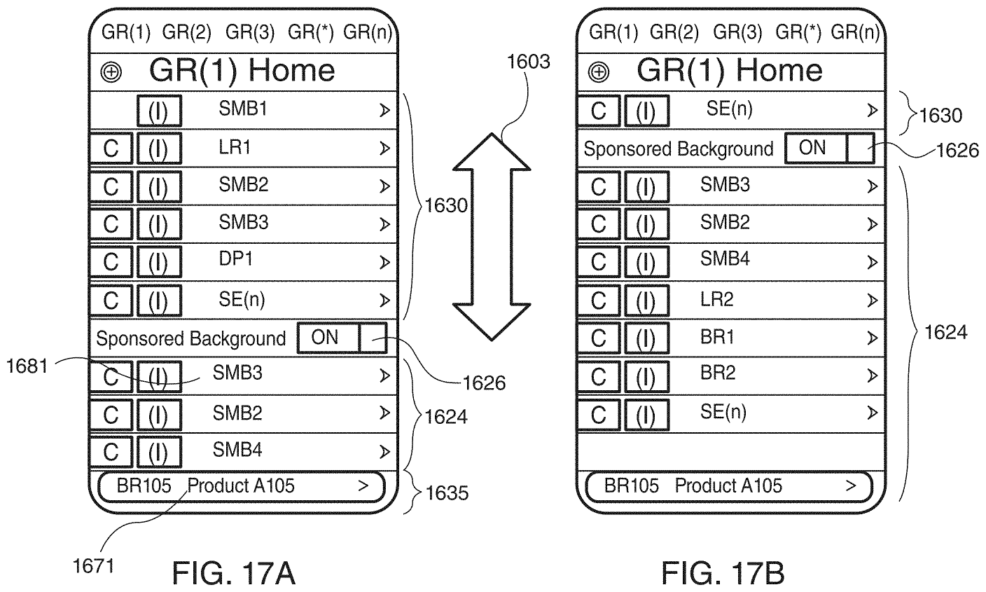

FIGS. 17A and 17B provide two views of the mobile device user interface with the sponsored background button 1626 set to on. As presented in data diagram 1401 of FIG. 15, the lower portions of the device display 1624 in FIGS. 17A and 17B are populated with the results of the bidding processes including the presentation of SMB3 as the winning bidder at the top of the lower display section. Further, BR105, the winning bidder in the premium reserved inventory placement is shown as the winner within a constant ad display 1671 within bar 1635 at the bottom of the user interface. Relative display portions of user input data display area 1630 and ad managed display portion 1624 may be changed by using the touch screen capabilities of the user interface to scroll up and down as shown by the direction of arrow 1603.

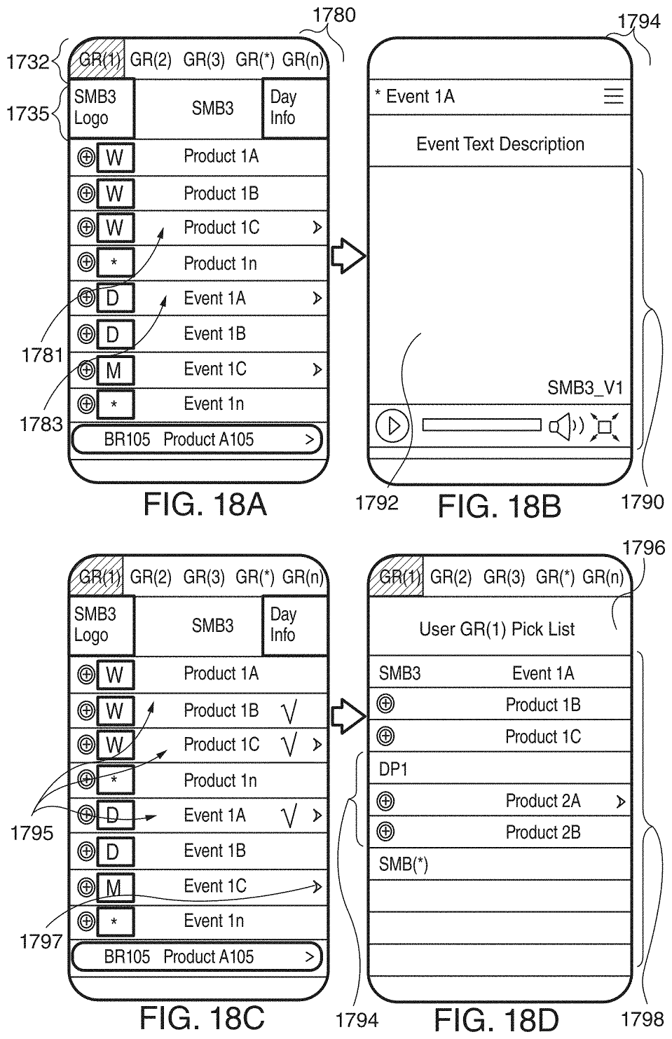

FIGS. 18A and 18B are an expanded view of the SMB3 listing shown in FIGS. 16 and 17. The SMB3 logo, unique geocode identifier and daily information are shown in a display bar 1735 provided immediately below the geo-reference selection bar 1732. The various products offered for sale, including product 1C 1781 are listed in the product display area along with the time codes related to the duration of the special product offerings (W=week; D-day; M=month). By using the touch screen functionality of the user interface, any one of the products or seller's events may be selected and displayed in detail as shown in FIG. 18B.

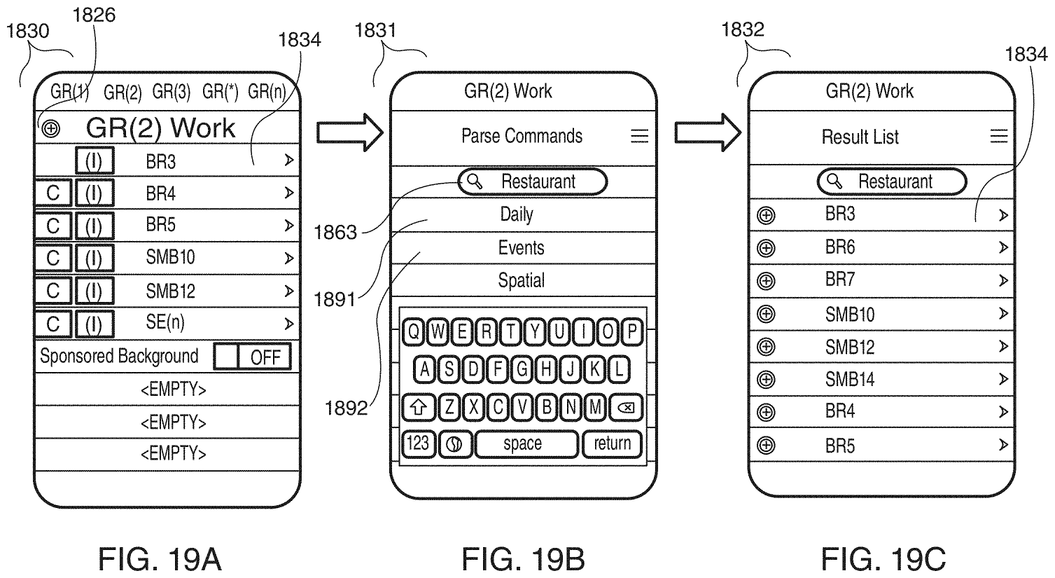

FIGS. 19A-19C display a sequence of user interface displays 1830-1832 that show the progression of steps that a buyer may employ while searching for products on a mobile device to arrive at a desired set of results. Referring to FIG. 19A, the buyer is shown to be displaying the user identified geo-reference GR(2)—WORK. By selecting the Parse Commands function (circle 1826) next to the present geo-reference indicator, the second user interface display 1831 is provided. Within FIG. 19B, various default selections are displayed such as daily promotions 1891 and promotional events 1892. By selecting one of these boxes, the buyer is presented with a full list of those items including related items that the user has received as a result of the user specified inputs. In the example of FIG. 19B, however, the buyer is presented with a textual search box 1863 into which a search term such as “restaurant” may be typed. Since the context in which the search was executed was with respect to geo-reference GR(2) WORK, the user device software and the ad server use this geo-reference, in combination with the buyer-input listing of restaurants of interest within GR(2), to condition and filter the search results from the local database, which are provided in FIG. 19C. It is seen from the results list there, that BR3 1834 which is on the user-input list of restaurants is returned as a search result along with some restaurants that are not within the buyer's preselected list. These non-geo-referenced restaurants may be populated and ranked by restaurants within a certain distance of GR(2) using the same bidding processes as those described in connection with FIGS. 13-15.

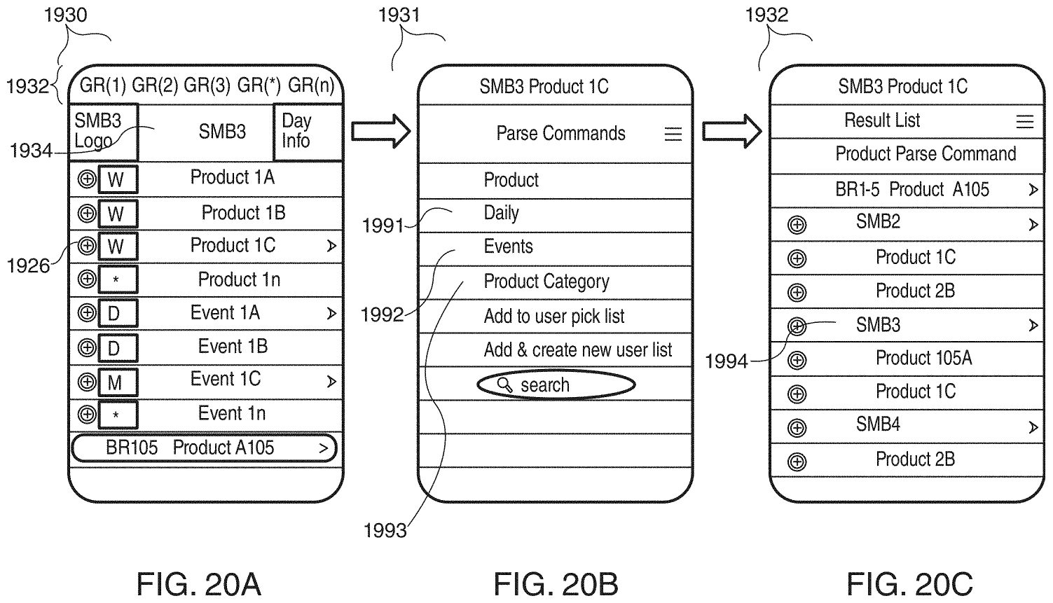

FIGS. 20A-20C provide a similar sequence of search displays and search result displays but with respect to a particular product of interest. Referring to FIG. 20A, the buyer is shown to be displaying the user-input seller SMB3 1934 beneath the geo-reference bar 1932. By selecting the Parse Commands function (circle 1926) next to the product 1C, the second user interface display 1931 is provided. Within FIG. 20B, various default selections are displayed such as daily promotions 1991 and promotional events 1992. By selecting one of these boxes, the buyer is presented with a full list of those items including related items that the user has received as a result of the user specified inputs. In the example of FIG. 20B, however, the buyer is presented with a product category command 1993 associated with product 1C. Since the context in which the search was executed was with respect to user-input SMB3, the user device software and the ad server use this data in combination with the other buyer-input listing of sellers of interest to condition and filter the product search results, which are provided in FIG. 20C. It is seen from the results list there, that SMB3 1994 which is on the user-input list of sellers is returned as a search result identifying it as a seller of product 1C along with a list of other sellers that are not within the buyer's preselected list. These non-product-referenced sellers may be populated by sellers that are within a certain distance of the geo-position of the GR(1) using the same bidding processes as described in connection with FIGS. 13-15.

It is precisely the situation in which the user has direct control to input a plurality of targeted sellers, specify parsing commands and geographic areas of interest, that enables the ad server on the user mobile device to deliver ads and offerings relevant to the user at precisely the moment in time the user is most engaged with shopping planning and decisions, the most efficient time to plant a seed for a brand or product. The present invention provides the user direct control over this data push function and the filtering of the returned results enabled by the pull dynamic and enables an innovative ad connectivity system to help build channel relationships between the user and seller. Intuitively the system and method embody and enables user loyalty with seller and ongoing engagement at a high level of interest for user. The user best knows the user intentions, motives and schedule. It only takes a mobile minute for a user to get a highly relevant view of specials, notices and promotions from their targeted sellers whether it is a shoe repair shop next door or a national food service chain 10 minutes away. The user's push-pull dynamic of the present invention enables the user to get the ads the user wants, when they want it, without sacrificing privacy. Further, significant time savings are afforded the user by optimizing the user's time to plan his or her shopping and taking the time, when scheduled, to compare price and value from various sellers. The user interface of the present invention would efficiently be integrated within the user process for shopping during the day, week, month, or holiday because it is primarily user driven.

The tracking and centralized methodologies of mobile advertising networks which have adapted the tracking cookie methodology from the online internet do not effectively deliver relevant ads and information to the user and in an efficient manner for user data consumption, user data costs, and mobile device battery life. Further the tracking and centralized methodologies of mobile advertising networks have an extremely high privacy cost to the mobile device user in exchange for advertisements and user service value that deliver low quality benefits acutely with local advertising to both mobile device users and for businesses seeking relevant advertising and relationships with mobile device users.

For many small and medium businesses (SMBs) seeking access to mobile advertising, building a mobile-optimized website is a starting point, but they often lack a viable search engine mobile strategy on a cost-efficient basis. Search is recognized as the primary method that a user finds a seller on mobile. Further many SMBs need an on-going, non-obtrusive channel with the user to present offers, reminders, and coupons and maintain user loyalty. Many large brands and large retailers have financial and human resources to access current media advertising networks and techniques. However, the value of localization to the user requires that all sellers be able to access the channel with user. Local sellers deliver convenience to the user with the seller being nearby and the attribute of having purchases come home or delivered. Local sellers are an integral part of the community or neighborhood where the seller can leverage face-to-face interaction and provide assistance. The seller traditionally places notices, specials, and advertisements on the frontage of their physical store location(s) to capture attention and draw foot traffic into their physical location from the existing and daily foot and vehicle traffic outside and nearby their physical store location(s). Therefore, for local advertising to have a meaningful value to a user, all sellers small and big need to access mobile advertising and access the channel with the user.

This invention is adaptable by all SMBs, large retailers, nationwide brand names, and mobile destination places to place ads and run mobile ad campaigns within any budget and on any scale. The system and methodology is adaptable to geo-centric campaigns as small as one urban block, neighborhood and scalable to entire urban city, state and regional geography, nationwide, and globally. The invention provides a comprehensive solution to provide local advertising and larger scale advertising campaigns.

Advertising Video Content-Management, Display and Distribution

Given the previously mentioned privacy concerns of the mobile device users, video advertising displayed on mobile devices poses its own special challenges. Advertising videos (alternatively “ad videos” or “video ads”) can take several forms. In the present mobile environment, video program contents are typically stored, streamed and distributed by centralized media servers with the video data being located on commercial cloud servers wherein the distribution network employs various network edge components to assist with the storage and distribution of the video content. One type of video program content is unicast, or video on-demand. This type of video stream is requested by the mobile device user using the mobile device and consists of a point-to-point, single session in which the requested video program content is played on the user's mobile deice. A second type of streamed video program content is a multicast stream in which the same video program content stream is transmitted or otherwise made available to a plurality of mobile devices, typically on an opt-in or a subscription basis. A variation of the unicast and multicast streaming distribution methods involves time-shifted streaming in which the mobile device user requests video program content and then controls the playback of the video stream by controlling a software application (alternatively an “app”) on the user mobile device, such as a media player. The media player may be used to designate cue points at which to begin the video stream or pause the video stream. A third type of streaming video content is a broadcast stream in which a plurality of mobile devices can access the same video stream in real time, point to multi-point. Broadcast video streaming is most easily recognized as today's typical TV network broadcast programming and typically involves a one-time, multiple user session in which mobile device users “tune into” a desired live video stream or live broadcast stream. In a live broadcast stream, the user typically cannot control the video playback unless they have been provided authority to control time shifting or recording of the video content, such as through the use of a media player coupled to the broadcast display device.

Ideally, sellers, retail stores and brands would like to have to have access to and target and track the location of mobile device users for distribution of their video advertising. However, SMBs or similarly-sized retailers do not have the resources, scale, or expertise to access a large number of mobile devices for advertising purposes. In tension with the sellers' desires, mobile device users are concerned with privacy, the costs associated with data consumption and the smaller screen sizes available on their mobile devices. The advertising video invention of the present application describes a solution in which advertising video chains are created by the system according to highly specific and relevant user preferences and recorded user activities.

As shown in FIG. 1, the advertising video distribution system provides for mobile device 22 that includes a media player 26. Media player 26 is coupled to and controlled by ad server 24. Ad server causes video-based ads to be played on the mobile device 22, specifically user interface 30, using media player 26. In addition, mobile device 22 includes one or more application program interfaces (APIs) 28 and one or more external applications 41. External applications 41 are software apps or software modules the are distributed by third parties, i.e. entities not affiliated with the service operator of the advertising video distribution system.

External apps may, for example, include those mobile apps created by video content providers, such as YouTube or Google, as well as other mobile applications that manage user's commercial affairs such as device wallets, loyalty membership programs or coupon redemption programs. Media player 26, API 28 and external applications 41 are all coupled to each other and to the user interface 30, ad server 24 and local database 40 within mobile device 22. They communicate with one another through various software and network messaging protocols.

Mobile network 50 is coupled to and/or includes a plurality of cloud-based advertising video distribution systems 90 that contain both video program content to be displayed on the mobile devices and advertising videos to be displayed in connection with the same. Cloud-based advertising video distribution system 90 includes the actual advertising video database 58, non-advertising, video program content database 56, and advertising video server 91. Advertising video server 91 may include, advertising video media server 92, advertising video API 93 and an advertising exchange 94. Advertising exchange systems are specific systems used by advertisers in which users' personal information is monitored independently by the advertising content video provider for the purpose of determining relevant distribution of video content. User location data, user past practices and user infographics are examples of the types of data collected by such exchange systems. Cloud-based, advertising video distribution systems 90 are coupled to the internet and to mobile network 50 through network connections 74.

In an alternative embodiment, the advertising video distribution system is a split system: one portion containing the video program content and associated system components, and the other portion containing the advertising video content and associated system components. In this embodiment, the video distribution system has control over the external application 41 and has access capability with respect to the advertising video distribution system such that advertising videos can be identified, transmitted and controlled by the video program content system and inserted into the display of the video program content when played on the external application 41.

Cloud-based video distribution systems may be collectors, managers, repositories etc. of video content distributors, both commercial and private, advertising-related and non-advertising related. Google, Amazon, YouTube, and Comcast are all examples of business that may have a cloud-based video distribution system as part of their business model. YouTube, for example, makes videos available for viewing on its internet web page in general as well as on its mobile device applications. YouTube has its own command, control of and access to the videos it displays along with advertising video content that is played as part of its streamed video offerings. Intimate collaboration, sharing, cross promotions and interactivity between all video content providers may be made and is being made outside the advertising video distribution system of the present invention. This is typically performed using individual mobile device applications offered the video content providers or through sharing of web site browsing information, for example, through the APIs operating on the mobile devices, often at the direction of media players on the devices. Such collaboration and sharing enable video streams to be constructed by one or more video content provider, and if needed, in collaboration with other video content providers.

Non-mobile consumer display devices are also coupled to the advertising video distribution systems 90 through network connections 76. By way of example, consumer display devices 97 may be televisions, stationary personal computers, or voice recognition systems connected to monitors (e.g. Amazon's Alexa connected to a monitor). Consumer display devices will typically have their own media players 98 that are coupled to the display devices and control the video content played thereon. Consumer display devices may also have their own external applications 99 coupled to the media server and display device that control, request or otherwise interact with video content offered by the advertising video distribution systems 90

External, public display devices 95 may also be coupled to the cloud distribution systems 90 through network connections 75. By way of example, public display devices 95 may be electronic billboards, advertising kiosks, public monitors at retail establishments or other such display devices. Public display devices will typically have their own media players 98 that are coupled to the display devices and control the video content played thereon. Public display devices may also have their own external applications 96 coupled to the display device that control, request or otherwise interact with video content offered by the ad distribution systems 90.

With respect to the content and organization of the streamed videos, ad video portions of the streams typically contain pre-determined or curated advertising videos embedded within an existing non-advertising video stream. The advertising videos are introduced into the overall video stream according to cue points within the non-advertising video stream such that advertising videos and non-advertising video content make up the overall resultant video stream. With respect to timing, the pre-determined or curated advertising video content may be shown to the user before the commencement of the non-advertising video content (pre-roll cue points), as embedded in-situ within the overall video stream at various cue points (mid-roll cue points), or after the end of the non-advertising video content (post-roll cue points). Advertising videos may also be viewed as an overlay to the non-advertising video content in which both the video ad and video content are viewed by the user simultaneously on the same mobile device screen. In one example, advertising videos may be shown in a designated display section at the bottom of the mobile device under the direction and control of the user's media player. Alternatively, the advertising videos may overlay the non-advertising video content in which the media player synchronizes the display of two or more display screens areas or even two or more display screen devices. For example, a television screen may be synchronized with a mobile device screen such that the non-advertising video content is displayed on the television screen and the advertising video content is displayed on the mobile screen.

Presently, curated advertising videos may be chosen by the media server 92 within the advertising video distribution system 90 with the aid of advertising promotion placements purchased by vendors and sellers. Dedicated advertising servers for selecting advertising video content outside the control of ad servers 24 on mobile devices 22 are located within those video distribution systems or alternatively at the edge devices in the cloud and mobile network 50. In the seller's ideal environment, such placement decisions are made according to user audience demographics, scale reach, frequency and/or data generated from location tracking of the user's mobile device and the harvesting of users' data pertaining to personal behavior on the mobile device. Text messaging, voice calls, mobile device web browsing history and data capture from external applications on the user's mobile device may all be targets of a sellers' criteria for advertising video selection and distribution. However, even with specific data regarding a user's habits on their mobile device, it is difficult for sellers and advertisers to control the frequency of the display of advertising videos and to make advertising videos relevant to each of a plurality of mobile device users that are simultaneously viewing a live broadcast stream. In tension with this, mobile device users do not want their physical location to be tracked for the for the purpose of receiving targeting advertising videos, or their data privacy to be compromised or a usurpation and disruption to the viewing experience of video content on their mobile devices. Advertising videos that appear spontaneously and uninvited are considered annoying and may not be contemporaneous with the user's actions involving the mobile device.

The present invention describes how the local ad server, 24 of FIG. 1 on the user mobile device 22 generates a preferred selection and list of advertising videos associated with a user list of preferred offerings 133 as shown in of FIG. 2. As described above, these preferred offerings are managed by the local ad server 24 which chooses the advertising videos to be presented along with a video stream played by the media player 26 of FIG. 1 on the user mobile device 22. Alternatively, the management of a mobile device user's advertising videos may be applied to other external consumer display devices 97 or public display devices 95.

Referring to FIG. 1, mobile device user 20 engages the user interface 30 on mobile device 22 and uses the local ad server 24 to create lists of preferred offerings 133 as previously described in connection with FIG. 2. As described, these preferred offerings are associated with a plurality of geo-reference points 132. Local ad server 24 on mobile device 22 selects data from the local database 40 consisting of advertising videos determined from the user lists of preferred offerings 134. Sponsored background advertising is described in connection with FIG. 15 and is also used by the ad server to determine relevant advertising videos of interest to the user, primarily based on the geo-reference points 132 specified by the user.

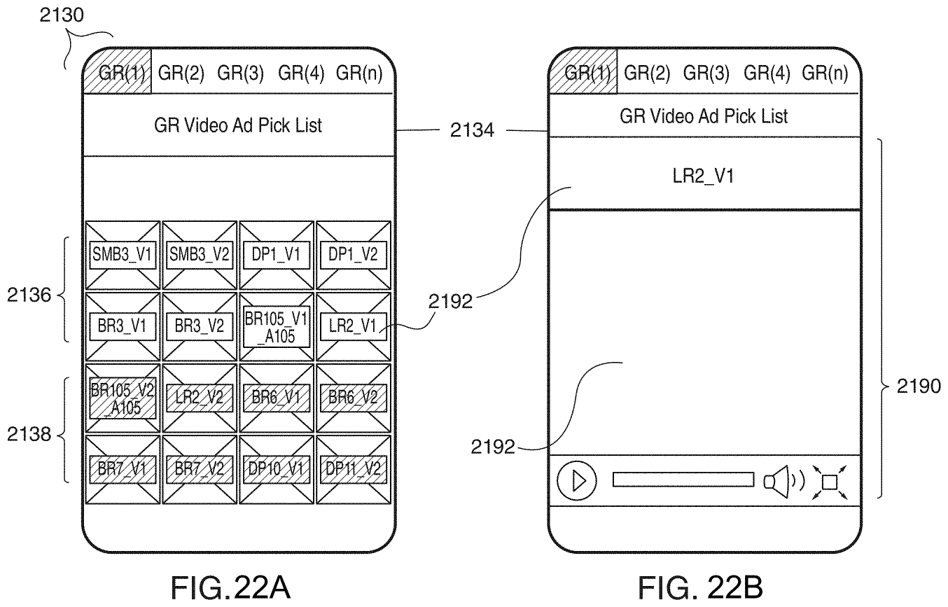

As an example, data diagram 202 of FIG. 3 shows the ad panel 286 which contains seller's advertising content 296. Datum 294 indicates that an advertising video has been entered into the ad panel and is related to Event 1A. Ad Code designation V in ad code identification column 299 indicates the video nature of the advertisement. As an example, advertising video V is a 15 second video ad sponsored by SMB3 271 that advertises an event 1A at the seller's location 261. Video ad V regarding event 1A at SMB3 is also shown on mobile device display area 1792 of FIG. 18B and is described in more detail in connection with FIG. 18B. Ad panel 286 is further expanded for the purpose of this invention to include video ad key column 287. Video ad key column contains the ad keys associated with the products or events offered by seller SMB3. As shown, video ad keys SMB3_V2 and DP1_V1 are associated with Product 2A and SMB3_V1 is associated with Event 1A. These associated video ad keys are discussed in more detail in connection with FIGS. 18 and 22.

In operation a metric log 150 of FIG. 2 is created, updated and maintained by local ad server 24 on mobile device 22 and as part of local database 40. Metric log is displayed as sub-database data diagram element 150 in FIG. 2. Metric log 150 contains a plurality of data fields, including but not limited to a video ad key 156 a preference 157 the dates of ad video viewing 158, the viewing duration of the video 155 and a maximum ad video viewing frequency 159. Ad viewing frequency can be further defined by a maximum number of video ad displays in a certain period of time. As one data entry 170, metric table 150 shows that the ad video SMB3_V1 is a listing of a preferred vendor SMB3 and that video was viewed on Sep. 21, 2018 for a full duration of 00:15. Finally, SMB3_V1 is limited in viewing frequency by the user to not be viewed more than 3 times per month.

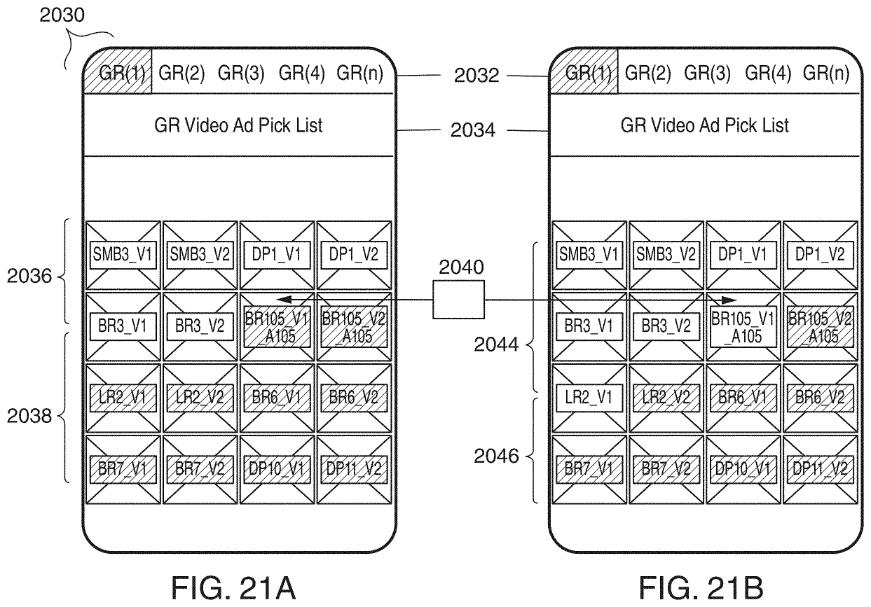

In sum, metric log 150 contains information regarding the advertising videos viewed on mobile device 22 based on measurable or recordable actions and activities executed by the user 20 through their interaction with user interface 30. The metric log is further intended to represent data pertaining to a resultant recorded list of actions taken by the user 20 as he or she interacts with the list of preferred offerings 133. Recorded actions include, among other activities, a summary of a mobile user's executed interface commands, executed key word searches, and other user interactive commands performed on the user interface 30. For example, the video ad Event 1A or SMB3_V1 played by the user 20 on the mobile device media player 26 for 15 seconds is a recordable action. This is shown in more detail and with specific relevance to a user action on FIG. 18A, 1783. There, Event 1A is listed and displayed as being available from seller SMB3. By touching the Event 1A 1783, a more detailed screen display is provided at FIG. 18B in which detailed information about Event 1A is provided. Selection of SMB3 in FIG. 18A and the display of the SMB3 logo 1735 are recordable actions. Selection of Event 1A and the detailed display of Event 1A 1792 in FIG. 18B is a recordable action. Selection of a new seller, e.g. SMB10 160 FIG. 2, chosen from the sponsored background 124 and added to a list of preferred sellers within 134 on the user interface 30 is a recordable action. In fact, any new seller vendor etc. chosen by the user by using the seller physical location device and added to a user's list of preferred sellers 134 is a recordable action. Selection of a specific video ad FIG. 21A, 2040 from a seller that is chosen to be added to a user preferred list of advertising videos FIG. 21B, 2040, is a recordable action.

As shown as 1190 FIG. 12,a plurality of mobile device users within a geographic area are shown including a display of the various sellers' geo-reference radii 1194, 1196, 1198. In this context, users are interacting with their mobile devices and are being provided advertising content, including video advertising content. The metric logs maintained on the mobile devices provide valuable feedback in the form of activity logs to the sellers, by which sellers can refine their marketing and offering strategies and further optimize the seller's advertising effectiveness.

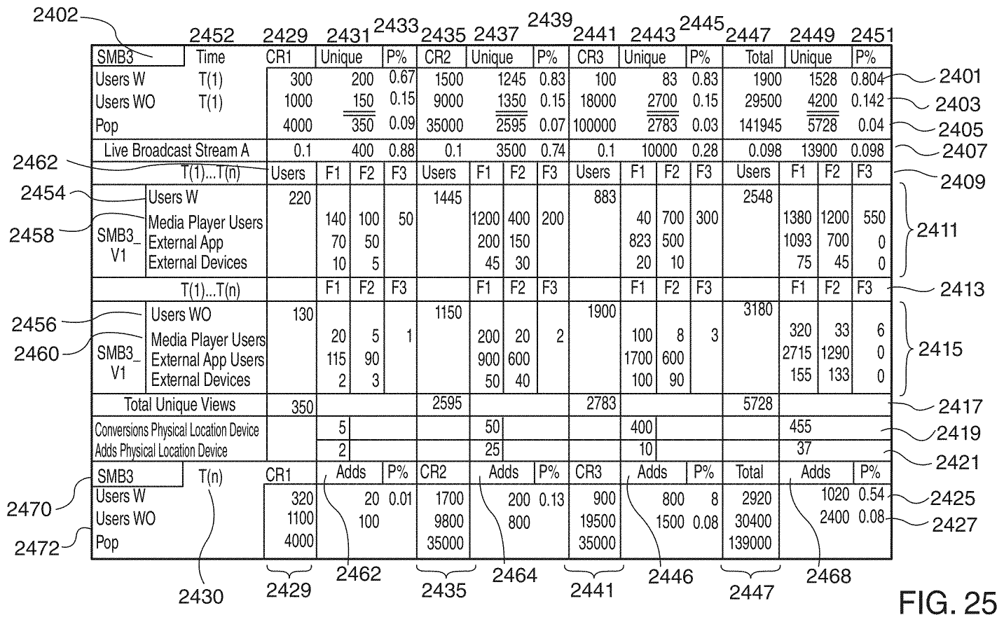

In operation, mobile device users will operate, shop, browse, and otherwise traverse the commercial environment of FIG. 12. As they do this, system users are continuously provided advertising opportunities of particular relevance to each user. Further, as the users browse these advertising opportunities, that browsing activity is recorded on the user devices, stored in the metric logs and transmitted to ISP 55. All user interaction information, including the plurality of metric logs, is stored in database 65 under the control of database manager 64. Thus, a plurality of metric logs from all the mobile device users within particular seller's geo-reference radius are recorded, collected, summarized and quantified so as to provide a framework of valuable feedback to the seller without the seller or other provider of video advertising content having to track the location user mobile device 22. As previously described, the system 10 of the overall invention makes all data available on an aggregate basis to sellers, without specific identification of or correlation to individual system buyer-users thereby preserving the privacy of the user 20. For the sellers, these recordable actions directly link a user-interactions at or proximate to a sellers' physical location so that the system of the present invention may also evaluate and determine a particular seller's advertising effectiveness. As described further in connection with FIG. 25, sales metrics can be generated and provided by the system of the present invention regarding the real-time advertising efforts, sales conversions and sales for buyers within those areas, and a resulting return on investment regarding the seller's offerings as it relates to advertising money spent. FIG. 25 provides more details regarding these recordable actions.

Referring back to FIG. 12, user 20 ad mobile device 22 have selected, as part of the user's preferred offerings 133, SMB3 when the user is at or proximate to geo-reference point GR(1). SMB3's video advertisement V1 is made available on mobile device 22 as shown at FIGS. 18A-B. This video delivery may be combined optionally with the anonymous delivery of Event 1A details and possibly as dependent on a proximity of the user to SMB3 as detected and reported by the system 10 of the present invention. FIG. 18B provides an expanded view of the SMB3 listing of Event 1A as provided in FIG. 18A after being selected by the user 20 through the touch screen functionality of the user interface 1730. The video ad SMB3_V1 1792 is now available to play by touching the play button at the bottom of the display after which the display area 1790 shows the advertising video within that display area. Any associated audio or visual functions that control that video are done so through the use of the media player 26 of user device 22. Video ad SMB3_V1 is promoting an Event 1A at the SMB3 location and is necessarily displayed on the mobile device 22 by the ad server 24 as a result of user's the preferred offerings in geo-referenced GR(1) established in local database 40. In this example, data diagram 140 FIG. 2 shows that the user has selected SMB3 as a preferred vendor when the user is in or proximate to GR(1). Alternatively, if the user happens to be in GR(1) and the user peruses sponsored background offerings, and selects the SMB3_V1 video for viewing, SMB3 may then transmitted Event 1A information as part of the updated user preferred offerings and associated preferences. This, of course, is all recorded in the metric log 150. Thus, by simply touching the play button to view advertising video content on a mobile device, the user 20 engages the local ad server 24 to stream a highly relevant video ad SMB3_V1 at a moment in time in which the user is most receptive to viewing it and in connection with the expanded listing of offerings for SMB3 1781, and 1783. At the end of the video, the local ad server 24 updates the metric log based on all recordable actions, including an advertising video playing time 173 and records a measurement of playing time +00:15 in the local database 40 to indicate the user 20 has viewed the video ad SMB3_V1 in FIG. 18B 1792 in its entirety of 15 seconds.

FIGS. 18C and 18D illustrate a user-created list called the user pick list 1796 while involved with geo-referenced location GR(1) (highlighted). The user pick list consists of individual sellers' offerings chosen by the user from lists of preferred sellers and as conditioned by the user geo-reference point GR(1). Three specific offerings 1795, shown as Product 1B, Product 1C and Event 1A at 1798, were chosen by the user by using the touch screen functionality of the user interface as indicated by the check marks within the SMB3 list of offerings shown in FIG. 18C. From prior shopping excursions and interaction with the ad server, the user 20 previously selected two offerings related to geo-referenced GR(1): Product 2A and Product 2B from the DP1 list of offerings 1771 FIG. 18D. The user's GR(1) pick list therefore contains a listing of products, events etc. at geo-reference point GR(1) by virtue of dynamically created “shopping lists” when in that area. These dynamic “pick lists” are supplemented by previously identified items of interest in that area. The local ad server 24 maintains the metric log based on all recordable actions and updates the metric log when the user adds the three specific product offerings, Product 1B, Product 1C and Event 1A to the User Pick List 1796. Product 1C in FIG. 5C shows an arrow 1797 for an expanded screen the user has not viewed. Event 1C and expanded screen are associated with video ad SMB3_V2 sponsored by a national brand that supplies and sells through SMB3 as part of the brand sales distribution. Product 2A in FIG. 18D also shows an arrow for an expanded screen the user has not viewed. By way of background information, that selection results in a display screen showing video ad DP1_V1. The User Pick List 1796 functions as a user reminder list, a list of user-selected, preferred offerings that may have potential customer interaction opportunities at the seller's physical location. Such interaction opportunities may include digital or real-world coupon redemptions or loyalty points collection and redemption according to a loyalty program organized by the seller. The ad server can be further programmed to cause the user pick list 1796 to interact with a user mobile device wallet, other external application 41, the seller physical location devices 60, or other external seller point-of-sale devices.

FIGS. 21A and 21B provide two views of the mobile device user interface 30 in which advertising videos pertaining to a particular geo-referenced point are displayed. FIG. 21A provides a view of the user interface 2030 presented by the local ad server 24 to the user on the mobile device user interface. The local ad server 24 has compiled an arrangement of local database elements consisting of advertising videos derived from the user-selected geo-references GR(1)-GR(n) shown at the top display portion 2032, the geo-reference bar. In the example of FIGS. 21A and 21B geo-reference point GR(1) is shaded indicating that a video ad pick list is being displayed for that geo-reference point and associated videos below are related to that location. The geo-reference point may be changed by swiping right or left on the touch screen interface at geo-reference bar 2032. The arrangement of local database elements consisting of advertising videos is identified as GR(1) Video Ad Pick List 2034 and is shown and presented in separate display sections 2036 and 2038. Section 2036 presents highlighted (white) squares or icons indicating advertising videos associated with the user's preferred offerings data 133 of FIG. 2. Section 2038 presents un-highlighted (black) video icons depicting sponsored background (bid on) ad videos and non-sponsored advertising videos relevant to the present geo-reference point GR(1).

The displays of FIG. 21 are made while the sponsored background button, 1626 of FIG. 17B, set to off. In one invention embodiment, the setting “off' on the sponsored background button results in no advertising videos being displayed that are not part of the user's preferred offerings. In the video consumption-friendly embodiment, shown in FIGS. 21, the sponsored background ad video icons are displayed despite the sponsored background button being off, but they are displayed un-highlighted (black) in display section 2038. Sponsored background advertising videos are displayed along with the videos advertisements directly related to the user's preferred offerings, which are unshaded (white) 2036.

The user controls the local ad server 24 through the touch-screen user interface 2030 in FIGS. 21A and 21B. Advertising videos associated with the user-created lists of preferred sellers that are within a certain distance of the user's geo-reference point of interest are sent to the user's mobile device based on previously input. preferred offerings and the data collected in the metric log. In this manner, geocentric associations between the user input geo-reference points GR(1)-GR(n) and a plurality of sellers' advertising videos SMB3_V1, SMB3_V2, DP1_V1, DP1_V2, BR3_V1 and BR3_V2 identified by their geo-reference points are made by the overall advertising system 10 of FIG. 1. Presuming that the user is present within or proximate to his or her geo-reference point GR(1)-GR(n), subsequent visitation of any of the sellers on the user's list would most likely require the buyer to drive a motor vehicle in order to reach any of the seller's physical locations. Again, with the assistance of the ISP 55, the user is enabled by the user interface on the mobile device to track advertising videos from the user-derived list of seller physical locations 2032 and determine the availability of specified events, products or brands of relevant interest; this, while also being provided relatively instant access to the proximate sellers relevant and timely promotions.

The overall display of seller's advertising video content is a configurable option on the user's mobile device. For, example, the user interface may provide the user the option to be made aware of certain advertising videos in section 2038 that pertain to certain sellers and brands regardless of the inclusion of a seller within the user profile or the user's actual geo-location. FIG. 21A shows display section 2038 in which advertising videos BR105_V1_A105, BR105_V2_A105, LR2_V1, LR2_V2, BR6_V1, BR6_V2, BR7_V1, BR7_V2, DP10_V2, and DP11_V2 are identified as un-highlighted (black) squares or icons. Since they are within geo-reference point GR(1) these advertising videos may optionally also be sent by the ISP to the user's mobile device based on the user's desire to see advertising videos not directly related to preferred offerings.

FIG. 21B shows the flexibility of the user interface 2030 in which the user 20 is able to add, rearrange or delete advertising videos through navigation of the user interface 2030 and the ad video icons. Using the touch-screen capabilities of the mobile device, the user has tapped two advertising videos from the sponsored background section, namely BR105_V1_A105 and LR2_V1. These advertising video icons are now highlighted and displayed in the updated section 2044. By virtue of this action, the user has engaged the ad server to add the two advertising videos BR105_V1_A105 and LR2_V1 to the preferred offerings 133 in local database 40. Further the user's interest in these videos is recorded int the metric log 150.

FIG. 22A demonstrates the flexibility of the user interface 2130 which enables the user 20 to rearrange the advertising videos through navigation of the user interface 2030. Upon saving the updated Video Ad Pick List 2034 in FIG. 21B, the local ad server 24 updates the metric log based on the user input data, primarily by adding advertising videos BR105_V1_A105 and LR2_V1 to the local database 40. The ordering of these videos in this interface can be later used to determine an advertising video playing order when creating an advertising video chain.

FIG. 22B is an expanded display of the Video Ad Pick List 2034 shown in FIG. 22A in which the two advertising videos selected by the user from the sponsored background section 2138 of FIG. 21A, BR105_V1_A105 and LR2_V1, have been rearranged by the user within display section 2136. The advertising video LR2_V1 is now capable of display in video display area 2192 through the usual functionality provided by the touch screen and media server. The advertising video LR2_V1 692 is sponsored by LR2, a large retailer. This large retailer is now on the preferred offerings list for the geo-referenced point GR(1) and retailers and vendors of LR2 products, specifically those that are the subject of the LR2_VR1 video, will now show up on the preferred offerings list when user 20 is within proximate distance to his or her geo-reference point GR(1).

In addition to user preferences and configurability by the user 20 to select relevant advertising videos, the local ad server 24 uses real time information from the mobile device such as time of day, day of the week, month of the year and season to choose advertising videos or the sequential arrangements of advertising videos. As mentioned The local ad server 24 also records and uses metric log information from the local database 40 to in determine which advertising videos to display or otherwise make use of. Two such data that the metric log records and uses are video play frequency and the viewing time lengths. For example, if advertising video LR2_V1 has been viewed by the user three times within a certain period of time, the local ad server 24 may choose not to select LR2_V1 in further video stream requests by the user. The user can specify a maximum frequency of video playing within a period of time so as to avoid ad fatigue. Once this frequency has been met the ad server prevents the subsequent playing of that video within the prescribed time period. The local ad server 24 may also use characteristics of the video content such as category, genre, time length, and keyword search attributes to select advertising videos or data arrangements of advertising videos.

The local ad server 24 may also use any of the data from the seller profile panel 282 to choose advertising videos or data arrangements of relevant advertising videos for display to the user. Video codes seller bidding panel 288 information, seller communication panel 290 information, textual reminders, pictures, and videos from external application on mobile device 22 are all capable of analysis by ad server 24 in the selection and display of relevant advertising videos. In this manner the local ad server 24 data can effectively analyze and select different combinations of relevant information on the mobile device but not limited to the list of preferred offerings to select an advertising video or data arrangements of advertising videos relevant to the user 20 and his or her current activities.

The following describes how local ad server 24 generates an advertising video chain. The advertising video chain can be used on the user mobile device as well as external applications on external consumer devices 97 and public display devices 95. As described in FIG. 22B, when the user requests a video stream, the media player 26 plays that video in display area 2190 of the user interface 2130. In FIG. 22B, the local ad server 24 picked the advertising video LR2_V1 2193 for the media player to play based on a simple advertising video chain generated from information from the user interface 2130 of an expanded view of the Video Ad Pick List 2134. Another example of how the local ad server 24 can be engaged is through an advertising video request originating from a media player on an external programmable application 41 residing on the same user mobile device 22. The local ad server 24 and the media server are capable of communication with the external application 41 through the transmission of messages and commands through an application program interface 26 (“API”). Therefore, the local ad server 24 can serve relevant advertising videos to a plurality of external programmable applications 41 residing on the user mobile device 22 as well as on other external programmable applications 99 and 96 residing on user external devices 97 and 95.

The local ad server 24 can be engaged by external programmable applications 99 and 96 not residing on the user mobile device 22 in order to deliver relevant advertising videos of a particular user. This is in lieu of traditional curated advertising videos otherwise viewed on the associated external devices 97 and 95 respectively. In this method, the local ad server 24 transmits the advertising video chain to the IPS database 65 under the management of the IPS database manager 64. These requests can be made in advance of the user being present at those devices or they can be made in in real time when the user is actually present at those external devices. The database manager 64 may receive a request for relevant video ad(s) through an application program interface (“API”) from an external media server 92, associated with the advertising video distribution system 90 or the request may be initiated by positive action of the ad server 24. In this manner, the local ad server 24 enables the ISP 55 to share the advertising video chain or data arrangement of advertising videos across the entire advertising video distribution network.

The following assumptions and definitions are applicable to the video streams described herein. External media player requests to the local ad server 24 or database manager 64 include ad format codes that indicate the size and type of videos that the media player can support. This is necessary so that both advertising videos and video streams can be played according to designated cue points. Further, the duration of the advertising videos at their designated cue points matches the duration of the otherwise scheduled video ads. Therefore, a 15 second cue point is matched with a 15 second video ad. The requesting media player makes the adjustments to account for any buffering and latency. The local ad server 24 often manages this in cooperation with the media player at advertising video load time.

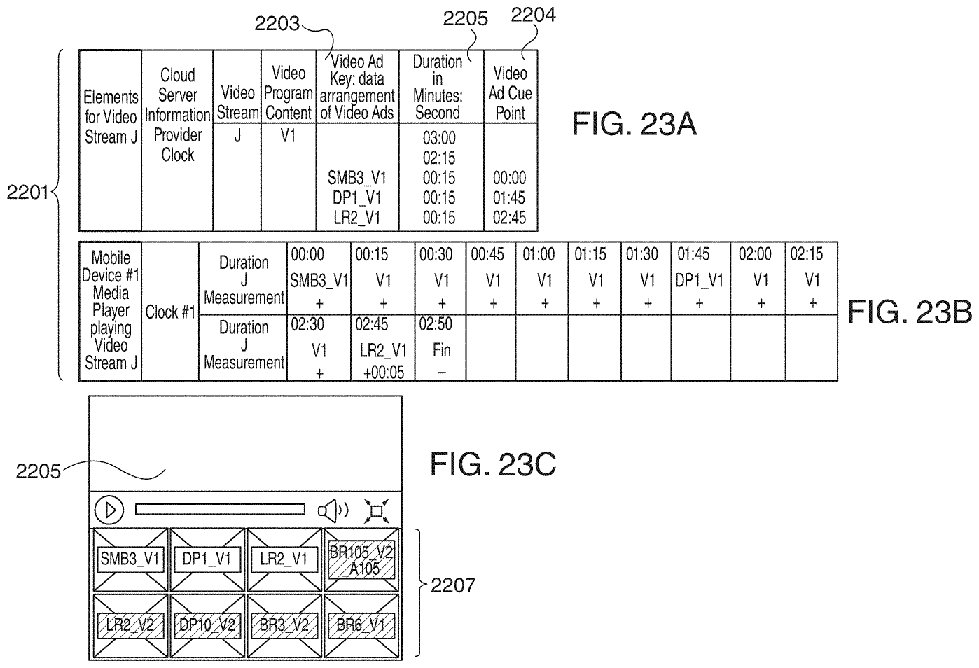

FIGS. 23A and FIG.23B display data diagrams 2201 showing a data-centric view of the elements constituting an on-demand video stream J. The on-demand video stream, requested by the user, is played with media player 26 or 98 coupled to or integrated as a part of an external programmable application 41 residing on a user mobile device 22, consumer external device 97 or public display device 95. With respect to the mobile devices of the present system, local ad server 24 selects the advertising videos and creates the associated advertising video chain associated with video stream J. FIG. 23A illustrates video stream J which consists of video program content V1 requested by the user 20 and which has duration of 02:15, or two minutes and 15 seconds. The external programmable application 41 receives from the local ad server 24 through its API 28, an advertising video chain to associate with the program content V1. The local ad server pulls known information about the advertising videos from the local database 40 or from ISP database 65. External programmable application 41 provides the local ad server through the API information regarding the video program content V1 into which advertising videos are to be inserted. The ad server or equivalent returns to the external programmable application 41 the following information: duration of video program content and overall video stream length, 02:15 and 03:00 respectively 2205; a list of video ad keys 2203 indicating the advertising videos to be displayed in video stream J; a list of video ad cue points 2204 indicating the desired placement of the video ads within the display of video program content V1; and optionally, the durations of each video ad 2205 at each video ad cue point. For the purposes of this example, the duration for each advertising video is 00:15 or 15 seconds and the video ad cue points illustrated are a pre-roll cue point at 00:00, a mid-roll cue point at 01.45 and post-roll cue point at 02:45. In practical applications, a short video of 02:15 duration may typically only have one ad cue point of 15 seconds advertising video duration or less.

With the timeline and ad code and format information, the local ad server 24 creates an advertising video chain for display with video program content V1 consisting of the following advertising videos: SMB3_V1, DP1_V1, and LR2_V1. This video ad chain 2203 was selected by the local ad server 24 based on analysis and evaluation derived from the user lists of preferred offerings, the sponsored background content and the associated recordable actions from the metric log within on local database 40. These are the three primary sources of information from which ads within the advertising video chains are selected and the chain constructed. This criteria can of course be expanded and other sets of criteria can be used by the ad server to determine that a particular advertising video is selected for display and viewing.

The examples provided in connection with FIGS. 18A and 18B are used below to select and construct the advertising video chain below. Advertising video SMB3_V1 was viewed in its entirety by the user. SMB3 is a vendor chosen by the user 20 within the user-created list of preferred offerings in relation to geo-reference point GR(1). Further, advertising video SMB3_V1 describes an upcoming event, Event 1A at the SMB3 physical location. Based on these preferences and recordable activities as memorialized in the metric log, ad server 24 selects SMB_V1 for inclusion in the advertising video chain. As an additional set of inclusion checks, local as server 24 then checks an expiration time as recorded by an associated time code in data region 297 of FIG. 3 for Event 1A 294 and compares it the real-time clock on the mobile device. Again, by way of example, if the local ad server noted Event 1A would begin that day, it may weigh in favor of displaying that particular video in the advertising video chain, Further considerations as whether the ad server selects SMB3_V1 are other recordable actions, particularly pertaining to prior viewing history stored within the metric log. A maximum viewing frequency may be configured by either individual users or the sellers themselves and taken into consideration in the selection process for advertising video chain creation. In one embodiment of the present invention, the frequency data is stored in the metric log 150. If previous views of the SMB3_V1 advertising video would cause that video to exceed that threshold then the ad server 24 will not selected that advertising video for the advertising video chain.

As a follow-on with the video selection example, Product 2A was added by the user 20 to the user's GR(1) Pick List 1796 as a product selection reminder. User preference DP1 within GR(1) is a preferred destination point within the user-created GR(1) list of preferred offerings. As shown in FIG. 3, advertising video DP1_V1 is associated with and describes Product 2A. Checking with metric log on the local database 140, the local ad server 24 noted the recordable action of inclusion of Product 2A within the User GR(1) Pick List 1796 and from information derived from the Ad Panel 286, the Ad Code V for Product 2A associated with advertising video DP1_V1. Further analysis of the metric log revealed the user 20 has not viewed the advertising video DP1_V1 to date, Therefore DP1_V1 is selected by the ad server as a mid-roll advertising video to associate with video program content V1.

As the third example of ad video selection, described in detail in connection with FIGS. 22A and 22B, advertising video LR2_V1 2192 was viewed in its entirety by the user 20. LR2 is a vendor user 20 is aware of but did not have a preference for until the advertising video LR2_V1 was selected from the sponsored ads and saved by the user 20 within GR Video Ad Pick List 2136. Video ad LR2_V1 2192 highlights certain specials for the week at the SMB3 physical location which includes Product 2A. As additional relevancy checks, ad server 24 checks the expiration of the time code for LR2 and the real time clock on the mobile device. Assuming that the time code indicates expiration of the video that day and based on the user 20 recordable actions of prior selection and/or viewing, i.e. the user inclusion of LR2_V1 within the GR Video Ad Pick List 216, the ad server selects the advertising video for inclusion in the advertising video chain. As a further check, ad server 24 can check that maximum playing frequency for that advertising video. After all consideration and relevant criteria are met, LR2_V1 is selected by the ad server as a post-roll advertising video to associate with Program Content V1. The local ad server 24 has now selected an entire advertising video chain to transmit to the external programmable application 41 through its API, to associate with the video program content V1 being played by the media player.

The above-described creation of the advertising video chain is implemented by the media player 26 on mobile device 22 as shown in FIG. 22B. Media player has access to the advertising videos which reside in the memory of the local database 40 through its API. In other embodiments, the media player may have access to the advertising video chain by virtue of its storage within the ISP database 65 under the control of database manager 64 or external media server 92. As illustrated in FIG. 23B, the video stream J is played consisting of video program content V1 interposed with the advertising video chain as defined by the video ad keys and their cue points for playing. At the termination of the playing of video stream J, the external programmable application transmits recordable action information through the API to the local ad server 24 for storage in the metric log. Specifically, a measurement playing time of 00:15 for SMB3_V1, 00:15 for DP1_V1, and 00:15 for LR2_V1 are stored in metric log 150. The local ad server 24 updates the metric log on the local database 140 with this information. The frequency for advertising videos SMB3_V1 and DP1_V1 is updated and information regarding their view time is updated as necessary. If video stream J was disconnected by the user at some midpoint and one advertising video was partially viewed for less than its full duration, then that information is stored. It is the intention of the present invention to make the metric log information available to the sellers, vendors, SMBs large retailers etc. so that they may make use of that viewing information for advertising purposes. This is, of course, done anonymously within the system and without attribution of any of the data to any one particular user. More precisely, the plurality of recordable actions associated with a user's activities within a particular geo-reference radius provides a framework of valuable feedback to the seller to further refine its selling strategies without the necessity of tracking the physical location of the user 20 or the user's own personal preferences and habits.

The advertising video chain created by the ad server may optionally be transmitted for storage to the ISP database 65. This makes that chain available to advertising content systems 90 such that that user's advertising video chain is available at devices other than the mobile device. As an example, the system 10 of the present invention can message advertising video providers 90 that anonymous customer X is now physically present at external display device 97 and forward that advertising video chain to the advertising content provider for distribution and display on that device over network communication links 75.

FIG. 23C provides for a user-configurable variation on the creation of an adverting video chain for display with video program content. In FIG. 23C the user is given the option of arranging the advertising video icons at the bottom of the display of mobile device 22 for specific, user-configured selection and inclusion within the advertising video chain. In this example, eight (8) relevant advertising videos are made available from which three (3) have been selected by the user as shown by the highlighted (white) video icons. The previously described selection criteria used by the ad server to determine user-relevant ad video candidates is used to create the initial list of potential advertising video candidates from which the user selects and arranges the advertising video chain. In any implementation, local ad server 24 interacts with the user interface 30 to provide the external application 41 the sequencing of the desired advertising video chain. The media server 24 can then determine appropriate cue points and transmit all that information to the external application 41 for display within the overall video stream.

The above-recited advertising video chain creation apparatus and methods can be used with any of the different types of video streaming. Through the use of distributed advertising video chains, the apparatus and methods of the present system can be used within national, regional and local advertising campaigns in numerous combinations of advertising arrangements.

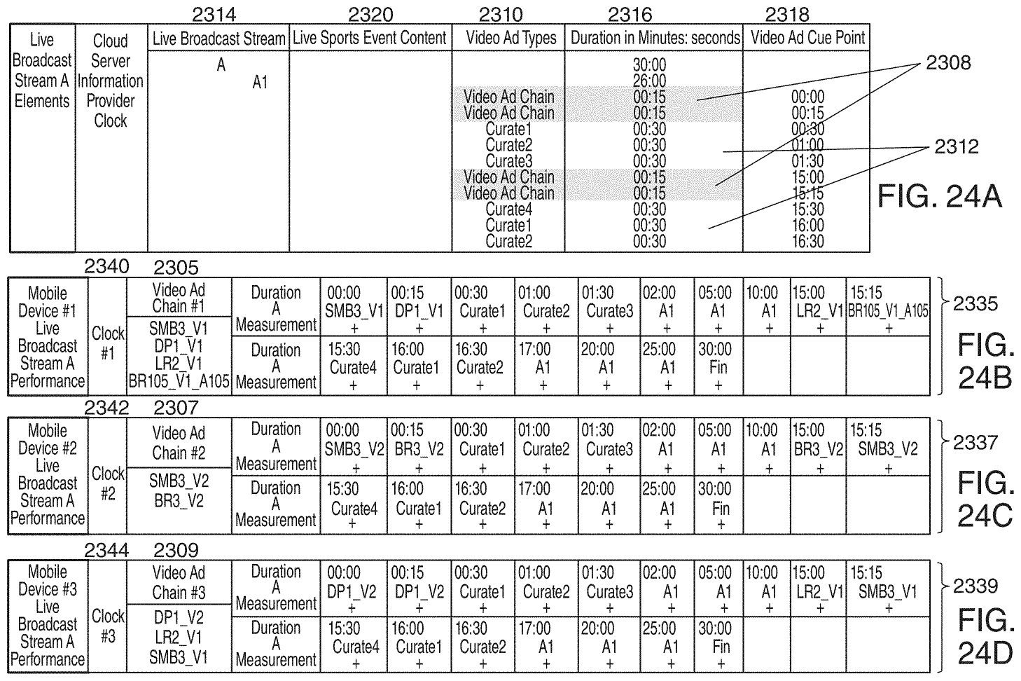

FIG. 24A is a data diagram that shows a data-centric view of elements for a 30-minute segment of live broadcast stream A 2314. Live broadcast stream A consists of live sports event content A1 of duration 26:00, leaving a duration of 04:00 in the 03:30 broadcast for the presentation of advertising videos 2303 and their associated chains (also designated “video ad types”) according to video ad cue points 2318. Typically, during a live sports event, there are pre-designated breaks according to the sports event game clock or designated breaks according to the sports event officials such as a referee time out. During these breaks in the live sports event content A1, the video ad cue points 2318 are triggered. Outside the mobile environment, live broadcast stream A 2314 is simultaneously made available through a media player from an external programmable application 99 residing on multiple external customer display devices. The video ad types 2310 are comprised of video ad chains 2303 and curated advertising videos, the latter being identified as Curate1, Curate2, Curate3, and Curate4 2312. The curated advertising videos are chosen by the centralized media server 92 located on the cloud-based advertising video distribution systems 90 that is transmitting live broadcast stream A 2314. The video ad cue points 2318 for video ad chains are used to by the external programmable applications 99 and 96 through the API 93 on the advertising video system to request a video ad keys 2305, 2307, 2309 created by the local ad servers 24 on each individual mobile device, #1-#3. As previously mentioned, this access is provided anonymously through the overall system 10 of the present invention through ISP database 65 under the control of database manager 64 Each individual local ad server 24 will select an advertising video chain to associate with live sports event content A1 on the respective mobile device 12 or proximate consumer external device 97. The selection process is the same as previously described with respect to all criteria, frequency and playability checks etc. in that the most relevant advertising videos for that respective user at that moment in time are selected.

The number of supported mobile devices can be extended to include the entire mobile device population accessing live broadcast stream A. For example, if five million mobile devices are accessing live broadcast stream A 2314 during duration 30:00 2316, then Mobile Device #N equals mobile device #5,000,000. In this example, mobile devices 1-3 are receiving live broadcast stream 2314 in its entirety and many other mobile devices within the entire system of population N can access the live stream at different times during the broadcast of the full program duration of 30:00. Therefore, this example is a point to multi-point, a one-time multiple user session (broadcast stream) which can be requested and accessed by the entire number N mobile devices 22 plus the user external devices 97 and 95.

In operation, the external programmable application 41 on each mobile device requests from the local ad server 24 on each device through its API, an advertising video chain to associate with live sports event content A1 2320. The external programmable application 41 has provided the following information to the local ad server 24: duration of live broadcast stream A 2316, 30:00; initial video ad cue points 2318 indicating placement within live broadcast stream A 2314. As shown in FIGS. 24A-D, the first two cue points are 00:00 and 15: each having a duration of 00:15 2016. In this example, the centralized media server has planned for an aggregate of one-minute duration for individual advertising video chains and three minutes for curated advertising videos over the course of the entire broadcast. Later, during live broadcast stream A 2314, the centralized media server 92 located on the cloud-based advertising video system 90 transmits to external programmable applications 41 the individual video ad cue points 15:00 and 15:15 and their duration. Local ad servers 24 through their APIs further select advertising videos to be played with and associate with live sports event content A1. The video ads can be selected by the ad server from local database 40 for each mobile device or the central media server can present video ad keys collected from system 10 and database 65. In either case, the ad server 24 directs the media server of the external programmable application 41 to play the advertising video chains at the appropriate times.

The following illustrates how the individual advertising videos for each advertising video chain 2305, 2307, and 2309 are selected for to each mobile device. FIG. 23B, displays the timeline and ad format code information in stream 2335. The local ad server 24 on mobile device 1 has selected video ad chain #1 2305 to associate and display with live broadcast stream A. Video ad chain #1 2305 consists of the following advertising videos” SMB3_V1, DP1_V1, LR2_V1 and BR105 V1_A105. This video ad chain 2305 was selected by the local ad server 24 based on the previously described analysis and evaluation of relevant user advertising videos. Further, once played, the ad server 24 for mobile device #1 stores all recordable events in the metric log 150 of mobile device 22 just as is done with on-demand video streaming. Specifically, the analysis by the local ad server 24 for selections of SMB3_V1, DP1_V1 and LR2_V1 have been as described in detail with text accompanying FIG. 23B. The selection of BR105_V1_A105 by the local ad server 24 was based on analysis that included a sponsored ad background placement within the expanded view of the SMB3 listing shown in FIG. 18A and the measurable action of the user 20 of adding video ad BR105_V1_A105 to the Video Ad Pick List 1734 as described with FIGS. 21A&B. The local ad server 24 checked with the metric log 150 on the local database 40 and noted that BR105_V1_A105 had a frequency of 0 which meant the ad had not been viewed by user 20. BR105_V1_A105 is a video sponsored by national brand BR105 for a product being distributed nationwide which includes vendor SMB3 as one of its distributors. Each of the four video ads for Video Ad Chain #1 805 has duration of 00:15 which in aggregate matches the projected aggregate Video Ad Chain duration 2303 of 1:00 for the duration 30:00. As illustrated in FIG. 24B, during the Live Broadcast Stream A 814, the external programmable application 41 transmits measurable action information through the API to the local ad server 24, specifically a measurement playing time of 00:15 for SMB3_V1, 00:15 for DP1_V1, 00:15 for LR2_V1 and 00:15 for BR105_V1_A105. The local ad server 24 updates the metric log on the local database 40 residing on mobile device #1 with this information. After updating, the viewing frequency for video ads SMB3_V1 and DP1_V1 has now reached three times within a period of a month and both video ads were viewed in their entirety. They will not be selected again by the ad server during the current month for display to that user.

FIGS. 24c and 24D operate similarly with respect to mobile device users #2 and #3 respectively. The dynamic nature of individual, user-defined advertising selection, chain creation and insertion into video streams, particularly broadcast video streams, is one of the very unique aspects of the present invention.

As illustrated in FIG. 9C, with the timeline and ad format code information, the local ad server 24 on Mobile Device #2 has selected video ad chain #2 2407 to associate with live broadcast stream A 814. video ad chain #2 2407 consists of the following advertising videos” SMB3_V2 and BR3_V2. On Mobile Device #2 this video ad chain was selected by the local ad server 24 based on analysis and evaluation derived from the user lists of preferred offerings and sponsored background associated with the lists of preferred offerings and the associated recordable actions from the metric log on the local database 40 maintained by the local ad server 24. The analysis includes real time information from Clock #2 2442, frequency of specific advertising video viewing, and information from the Seller Bidding Panel 288. SMB3_V2 is a video ad associated with Product 1C which is sponsored by a national brand, distributed at SMB3 and was specifically chosen by user 20 for a user pick list specified by a user geo-reference point. BR3_V2 is a lunch quick service provider that user 20 frequents and has included within a list of preferred offerings specified by another user geo-reference point. The local ad server 24 checked with the metric log on the local database 40 and noted that both SMB3_V2 and BR3_V2 had a frequency of 0 which meant these advertising videos had not been viewed by user 20. Each of the two advertising videos for Video Chain #2 2407 has duration of 00:30 which in aggregate matches the projected aggregate video ad key duration 2403 of 1:00 for the duration 30:00. As illustrated in FIG. 9C during the live broadcast stream A, the external programmable application 41 transmits recordable action information through the API to the local ad server 24, specifically a measurement playing time of 00:30 for SMB3_V2 and 00:30 for BR3_V2. The local ad server 24 updates the metric log on the local database 40 residing on Mobile Device #2 with this information. The frequency for advertising videos SMB3_V2 and BR3_V2 has now been updated to two times within a period of a week and both advertising videos were viewed in their entirety. During live broadcast stream A both SMB3_V2 and BR3_V2 were viewed in their entirety for one-minute 2437 and this recordable action for Advertising video SMB3_V2 is valuable to vendor SMB3 and the national brand for Product 1C.

As illustrated in FIG. 9D, with the timeline and ad format code information, the local ad server 24 on Mobile Device #3 has selected video ad chain #3 2409 to associate with live broadcast stream A 814. video ad chain #3 2409 consists of the following advertising videos DP1_V2, LR2_V1 and SMB3_V1. On Mobile Device #3 this video ad chain was selected by the local ad server 24 based on analysis and evaluation derived from the user lists of preferred offerings and sponsored background associated with the lists of preferred offerings and the associated recordable actions from the metric log on the local database 40 maintained by the local ad server 24. The analysis includes real time information from Clock #3 2444, frequency of specific advertising video viewing, and information from the Seller Bidding Panel 288. DP1_V2 is an advertising video for an expanded list of weekly specials at a department store and includes Product 2A which is on sale and was specifically chosen by user 20 for a user pick list specified by a user geo-reference point. LR2 physical location is a competitor to DP1 at a nearby physical location, therefore user 20 on Mobile Device #3 is included within the geo-centric association CR3 FIG. 12 118 for both vendors. LR2_V1 is a sponsored advertising video that user 20 has not included within a list of preferred offerings but is within distance specified by a user geo-reference point. The local ad server 24 checked with the metric log on the local database 40 and noted that both DP1_V2, LR2_V1 and SMB3_V1 have a frequency of 0 which meant these advertising videos had not been viewed by user 20. SMB3 is a vendor chosen by user 20 within a user list of preferred offerings and the advertising video SMB3_V1 describe an upcoming event 1A at the SMB3 physical location. DP1_V2, LR2_V1 and SMB3_V1 have durations 2439 of 00:30, 00:15 and 00:15 respectively which in aggregate matches the projected aggregate video ad chain duration of 1:00 for the duration 30:00. As illustrated in FIG. 24D during the live broadcast stream A 2414, the external programmable application 41 transmits recordable action information through the API to the local ad server 24, specifically a measurement 2439 playing time of 00:30 for DP1_V2 and 00:35 for both LR2_V1 and SMB3_V1. The local ad server 24 updates the metric log on the local database 40 residing on Mobile Device #3 with this information. The frequency for advertising videos DP1_V2, LR2_V1, and SMB3_V1 has now been updated to one time within a period of a week and all advertising videos were viewed in their entirety. During live broadcast stream A DP1_V2 was viewed in its entirety of thirty seconds 2439 and this recordable action for advertising video DP1_V2 is valuable to vendor DP1 and the national brand for Product 2A. During live broadcast stream A LR2_V1 was viewed in its entirety of fifteen seconds 2439 and this recordable action for advertising video LR2_V1 is valuable to vendor LR2. During live broadcast stream A SMB3_V1 was viewed in its entirety of fifteen seconds 2439 and this recordable action for advertising video SMB3_V1 is valuable to vendor SMB3.

FIGS. 9A, 9B, 9C and 9D represent one embodiment illustrating the dynamic selection of advertising videos relevant to each of a plurality of mobile devices 12. The methodology can be applied to a plurality of user external devices and external applications and seller devices.

FIG. 25 provides a data snapshot illustrating numerous aspects of the system-generated data and metrics that can be made available to sellers, brands, SMBs and vendor within the system. Historically, statistics regarding the video viewing habits of consumers have been limited to those of broadcast media and its associated advertising. From 1950 to present, these habits have been monitored with meters connected to telephones, set top boxes coupled to cable systems and lately through the use of tags inserted by the video content streams delivered by video content providers. Monitoring and rating agencies such as Nielsen Media Research collect and collate this information and feed this back to the video content providers and the advertisers who use that data to determine program popularity and advertising effectiveness among other uses. These methods of data collection and dissemination have been rendered obsolete and ineffective in the modern, cloud-based, mobile device-driven information age. The system, methods and apparatus of the present invention attempt to remedy the shortcomings of these older systems.

FIG. 25 provides one example of information presentation for seller SMB3 2402 regarding the public's view of one particular video associated with that seller: SMB3_V1. In sum a plurality of metric logs from a plurality of mobile device users are collected by system 10 of the present invention during a one-week period in which SMB3_V1 is distributed by SMB3 within the geographic areas illustrated in FIG. 12. The entire table depicts the three separate geographic areas of interest CR1 1194 as 2429, CR2 1196 as 2435 and CR3 118 as 2441. These three areas are the aggregated areas for the geo-reference location and radius of seller SMB3 1190. At row 2401 “Users W” displays the number of mobile devices that are part of the system 10 and that and that have designated SMB3 as a preferred seller at location GR(1). This is divided by geographic areas CR1 (column 2429), CR2 (column 2435) and CR3 (column 2441, including a sum TOTAL (column 2447) of the three areas. At row 2401 the number of unique “Users W” who have viewed video ad SMB3_V1 sponsored by SMB3 are shown under the “Unique” designation for each geographic area 2431, 2437, 2443, and the sum TOTAL at 2449. The penetration percentage, as a ratio of “Unique” video viewers to “Users W” is displayed for CR1 at 2433, for CR2 at 2439, at CR3 at 2445, and for the TOTAL at 2451.

At row 2403 “Users WO” displays the number of mobile devices of users on the advertising system 10 that do not have a geo-association that is co-located with SMB3 and do not have SMB3 in the preferred offerings at a geo-reference radius co-located with SMB3. However, “Users WO” are users of the system of the present invention (and therefore trackable) and have been detected by the system as begin are within the geo-reference radius for SMB3 (including CR1, CR2 and CR3). The same division among geographic areas and a TOTAL are provided for “Users WO” as are provided for “Users W.” At row 2405 the entire population “Pop” for each geographic areas CR1, CR2 and CR3 are provided and displayed respective table areas, with the data separated and organized as previously described. Note that the “Unique” Totals for “Users W” and “Users WO” are summed and listed in the Pop row, and that particular total is not the total population viewing the video. Instead, that is shown on line 2407.

The top rows of the display 2401 to 2407 show only the viewership demographics at time T(1) (Column 2452). An entire time period of data for T(1) through T(n) is shown separately for “Users W” (Rows 2411) and “WO Users” (Rows 2415). Sellers can define the time period of interest (Tn) 2430 during which the plurality of metric logs is collected by the system 10. By way of example, the time period T(n) is a one-week period (unit of “n” is days; n=7). Other units of time other than daily data can be collected as well. Some data summaries, breakdowns and identifications provided by the system of the present invention regarding people who have viewed the video are provided below:

SMB-V1 viewers in T(1)

| | | Potential | Unique | |
|---|---|---|---|---|
| Geographic | User | Viewer | Viewer | |
| Area | Type | Number | Number | Penetration % |
| CR3 | Users W | 100 | 83 | 83% |
| CR3 | Users WO | 1800 | 2700 | 15% |
| CR3 | Pop | 100000 | 2783 | 2.8% |

Row 2407 other information pertaining to the live broadcast stream A is collected and calculated by the system 10. In particular, the total number of the population who have viewed the advertising video SMB3_V1 is provided, as reported by the sellers or other information gathering services that have visibility into the overall population including those buyers not within system 10, Note that the total views of 350 in the line 2405 represents a sum of the “Users W” and “Users WO” and does not represent the total population number that viewed the video. That is shown at 2407 as 400. At line 207, a total population of 4000 at CR1 with 400 unique views is shown, 350 coming from system users. Also calculated by the system is the percentage of total population viewing the video (400/4000 or 0.1) and percentage of all viewers generated by the system 10 (88% or 0.88). These statistics are calculated for each areas as well , CR2, CR3 along with the TOTAL. All are shown at line 2407.

The entire week's viewership is collected, calculated and displayed by system 10 in the areas 2411 and 2415 for the “Users W” and “Users WO” populations respectively. Reading left-to-right, line 2462 shows the days of interest (T(1) to T(n)) the number of users (Users) and the frequency of video views (F1, F2, F3). Users in each group who viewed the video once are collected, calculated and displayed in the column(s) F1. Second video views (F2) and third-time (F3) viewers are collected, calculated and displayed as well. Line 2454 shows that 220 total SMB3_V1 video views were made by “Users W” during the week in CR1. Of that number, 140 were viewed using the media player 26 on mobile device 22 and using the system 10 of the present invention. Further, 70 of the initial video views were made through external application 41 without the aid of the ad server 24 and the media player 26. Finally, 10 were viewed by “Users W” when viewing them with external devices 97 and 95. Within the “Users W” population that week in CR1, 100 of the media player users watched the ad video 2 times and 50 watched it a third. The system 10 of the present invention collects all this information by virtue of the control it possesses over the mobile devices 22 which relay to the ISP 55 all metric log data of regarding the advertising video viewing of the individual mobile devices 22 and the video viewing that occurs through the use of stored user profiles and metric log data.

Equivalent data is collected, calculated and displayed in the respective areas for the other geographic areas CR2, CR3 and the TOTAL for the SMB3 georadius.

Similarly, the entire week's viewership is collected, calculated and displayed by system 10 in the areas 2415 for the “Users WO” population. Reading left-to-right, line 2413 shows the days of interest (T(1) to T(n)) the number of users (Users) and the frequency of video views (F1, F2, F3). Users in each group who viewed the video once are collected, calculated and displayed in the column(s) F1. Second video views (F2) and third-time (F3) viewers are collected, calculated and displayed as well. Line 2456 shows that 130 total SMB3_V1 video views were made by “Users WO” during the week in CR1. Of that number, 20 were viewed using the media player 26 on mobile device 22 and using the system 10 of the present invention. Further, 115 of the initial video views were made through external application 41 without the aid of the ad server 24 and the media player 26. Finally, 10 were viewed by “Users W” when viewing them with external devices 97 and 95. Within the “Users WO” population that week in CR1, 5 of the media player users watched the ad video 2 times and 1 watched it a third. The system 10 of the present invention also collects all this information by virtue of the control it possesses over the mobile devices 22 of “Users WO” which relay to the ISP 55 all metric log data of regarding the advertising video viewing of the individual mobile devices 22 and the video viewing that occurs through the use of stored user profiles and metric log data.

Equivalent data is collected, calculated and displayed in the respective areas for the other geographic areas CR2, CR3 and the TOTAL for the SMB3 georadius.

Total unique views for the week is collected, calculated and displayed at 2417. At row 2419 under “Unique” 2431, 2437, 2443 the number of conversions from unique mobile devices is shown under each of the geographic areas. For this example, SMB3 has defined within its communication panel 90 a real-time user interaction available during the day of Event 1A and associated therewith to retrieve an in-store-only 30% discount on a promoted item. SMB3 make this available for sale during Event 1A which provides an enhanced customer experience interaction with the assistance of the physical location device 460 containing the communications pane 90. Each of the “Users W” who retrieved the digital coupon code for redemption at the point of sale for Event 1A is a “conversion” under “Unique” (columns 2431, 2437 and 2443 at row 2419). At row 2427 under “Unique” 2431, 2437, and 2443 the number of new “Users W” added during the time period T(1) . . . T(n) is collected, calculated and displayed from the physical location device. At row 2425, the final number of new added “Users W” added during the time period T(1) . . . T(n) is collected, calculated and displayed at the end of the time period T(n) as shown under “Adds” 2462, 2464, and 2466. At row 2427 percentage increase or decrease of “Users W” from T(1) to T(n) is are also calculated and displayed.

Rows 2470 and 2472 show various pick-up customers of SMB3 and the addition of video viewers. Adds are those that were added as a result of the interaction with seller devices 460. Adds have been added to the overall totals for the “Users W” and “Users WO”. The percentages at line 2425 are pickup rates for those devices.

Through the Bidding Panel 288, for time period T(1) . . . T(n), SMB3 bid and won an advertisement placement for SMB3_V1 to be made available by a video ad chain submitted to the API on the mobile device 22 for the external programmable application 41 providing live broadcast stream A. The focus of the marketing strategy was to increase awareness of SMB3 by promoting Event 1A in geographic area CR3, where SMB3 had the least number of “Users W” (100) and the most available number of “Users WO” (18000) on system and within the seller georeference radius. The date in FIG. 25 provides SMB3 hidden insight within correlations of data and identifies opportunities which can be inferred by SMB3 through its own analysis or can be automatically generated by analysis performed by Database Manager 64.

In the example of FIG. 25, the data shows there was a network effect in CR3 during the time period T(1) . . . T(n) of adding “Users W” from exposure to SMB3_V1 on the live broadcast stream A correlated by the number of Adds 2466 of 800 at row 2425 and the increase of 823 Users W 2443 at API mobile device row 2411 for F1 and further the increase of 700 Interface 30 for F2 943 when contrasted to the 83 Users W under Unique 2443 at row 2401. To explain the sharp volatility at Interface 30 row 2411 where frequency gyrated from 40 to 700 at F2 2443 and 300 at F3 2445 knowing there were only 100 Users W and 83 users W with unique views at T(1), meant out of the 2700 Users W 2443 at row 2403 under Unique for T(1), during the period T(1) . . . T(n) there was a good conversion of Users WO to Users W from the live broadcast stream A which then viewed the video ad again through the Interface 30 causing the increase and volatility in frequency. The end result was an eight-fold increase in the number of Users W from 100 to 900 as per row 2425 under CR3 2441. The network effect carried to the physical location of SMB3 as indicated by the 400 Conversions shown at row 2419 where 400 Users W 2443 interacted with the physical location device to obtain the 30% discount promotion code during Event 1A. The information at rows 2411 and 2415 associated with the number of “Users W” 2454 and “Users WO” 956 in connection with video ad SMB3_V1 represents very powerful granular viewing data without the need for physical location tracking of mobile devices, harvesting significant quantities of data from tracking of mobile device activities and harvesting personal data.

The conversion of adding 1,020 Users W 2470 at row 2425 under Adds 2462, 2464, 2466 and 2468 during the one-week period confirms a quality reach and high engagement within all the geographic areas by the relevance of the video ad SMB3_V1 with Users W 2470 and Users WO 2472 with further potential to refine and continue the marketing strategy just implemented. The largest opportunity for conversion and exposure to new “Users W” for SMB3 continues to be under the CR3 2441 geographic area as shown by 19500 Users WO 2472 at row 2427.

Therefore, the data centric table or measurement dashboard represents touch points of an attribution model which is used by SMB3 to evaluate and determine effectiveness in real-time on conversions, aggregate number of User W additions 2462, 2464, 2466, and 2468, the correlation of sales at the SMB3 physical location after live broadcast stream A was aired, and provides effective information to calculate the return on investment of the bidding for advertising placement for live broadcast stream A.

SMB3 can generate a separate metric table for video ad SMB3_V2 utilizing the same methods described above. Of note, although video ad BR105_A1_105 advertised a national brand sold at SMB3 and was shown on live broadcast stream A, it is not included in this metric table because the geo-reference radius for national brand are different and significantly larger than the seller geo-reference radius for SMB3 and a separate weekly metric log would be generated by the Cloud Server Information Provider exclusively for BR105.

The table above illustrates a subset of information from the plurality of metric logs associated with the seller SMB3 geo-reference radius. The metric log can include a plurality of user external devices 97 and external applications 99. The invention allows information to be refined according to changing periods of time including real time and display of other variables which can include information controlled by the seller and associated with the Ad Panel 286, Bidding Panel 288, and Communication Panel 290 which the seller SMB3 may find useful for their own evaluation purposes. The invention derives an attribution model in real-time from the metric logs maintained by the local ad server 24 on the local database 40 which provides a powerful analytic tool with the ability to gauge conversion and sales effectiveness without tracking the physical location of the user.

By utilizing the system and method described, a significant reduction in “large data problems” are achieved.

Computer Systems, Architecture, Hardware and Software.

The methods apparatus and systems described herein may be deployed in part or in whole through one or more machines that execute computer software, program codes, and/or instructions on a processor. The processor may be part of a server, client, network infrastructure, mobile computing platform, stationary computing platform, or other computing platform.

A processor may be any kind of computational or processing device capable of executing program instructions, codes, binary instructions etc. The processor itself may include memory, for example within a single integrated chip, in which the processor stores methods, codes, instructions and programs as described herein and elsewhere. Each processor may include one or more associated or coupled memories from which the instructions are executed. The memories associated with the processors and containing the operational instructions may be local to the processor (e.g. directly coupled by bus architectures, computer connectivity ports, cables etc.) or they may be remote from the processors (e.g. located physically disparate from the processor such as over a local, wireless or broadband network, etc.). The processor may be or include a signal processor, digital processor, embedded processor, microprocessor or any variant such as a co-processor (math co-processor, graphic co-processor, communication co-processor etc.) each, every, any and all or subgroup of which may directly or indirectly facilitate execution of program code or program instructions stored thereon and in the associated memories.

In addition, the processor may enable execution of multiple applications, programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code.

The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

While the invention has been shown and described with reference to specific preferred embodiments, it should be understood by those skilled in the art that various changes in form and detail may be made therein without departing from the spirit and scope of the invention as defined by the following claims

The invention claimed is:

1. A computer-based distribution system for providing advertising videos to buyers within said system, said computer-based distribution system including a computer-based mobile network, said computer-based distribution system comprising:
at least one computer-based mobile device used by a buyer within said system, said buyer mobile device coupled to said computer-based mobile network, said mobile device including a processor and an associated memory for storing instructions executed by said processor; said mobile device using said processor for executing programs on said mobile device, said mobile device having:
an ad server programmed as software application operating on said mobile device;
a local database coupled to said ad server, said local database configured to store buyer profile data elements, said buyer profile data elements including buyer-specified advertising content, including at least one of a seller, a product or a service, said buyer profile data elements also including a buyer-specified geographic area, said buyer profile data elements comprising said preferred offerings of said buyer;
a media player coupled to said ad server, said media player programmed as software application operating on said mobile device, said media player capable of being controlled by said ad server;
an external application coupled to said media player, said external application programmed as software application operating on said mobile device, said external application programmed to play video streams on said mobile device, said video stream including video program content and advertising video content, said external application using said media player to play said video stream; and
a user interface coupled to said ad server, said user interface used by said buyer to store said buyer profile data elements in said local database, said user interface being used to control said media player and said external application and play video streams on said mobile device;
at least one computer-based advertising video distribution system operated by an advertising video provider within said distribution system, said advertising video distribution system coupled to said computer-based mobile network, said advertising video distribution system providing said advertising video content, including advertising videos, to said mobile device over said mobile network, said external application using said provided advertising video content and said provided advertising videos within said video streams played by said external application using said media player; and
wherein said ad server stores advertising videos played by said buyer on said mobile device in said local database based on said preferred offerings of said buyer, said advertising video distribution system transmitting advertising videos to said mobile device, said advertising videos within said advertising video content played by said external application on said mobile device using said media player, said ad server replacing at least one of said provided advertising videos with said advertising videos associated with said preferred offerings of said buyer.

2. The system of claim 1 wherein said preferred offerings includes a buyer profile data element comprising a retail store at a geographic area, said retail store distributing an advertising video on said mobile network, said buyer using said mobile device to play said advertising video of said retail store, said ad server storing said advertising video of said retail store in said local database, said ad server replacing said provided advertising video with said advertising video of said retail store when said buyer is in said geographic area and said external application is playing a video stream with said media server on said mobile device.

3. The system of claim 1

4. The system of claim 1

5. The system of claim 2 wherein.

6. The system of claim 2 wherein.

7. The system of claim 1.

8. The system of claim 1.

9. The system of claim 1.

10. A computer-implemented method for providing advertising videos to buyers within a computer-based distribution system, said computer-based distribution system including a computer-based mobile network, said computer based mobile network coupled to a computer-based mobile device and at least one computer-based advertising video distribution system operated by an advertising video provider, each computer-based device, server and system having a processor and an associated memory for storing instructions executed by said processors, said mobile device using said processor for executing programs on said mobile device, said method comprising:
activating a user interface on said mobile device by a buyer;
storing buyer profile data elements in a local database on said mobile device by said buyer using said user interface, said buyer profile data elements being stored using an ad server on said mobile device coupled to said local database, said ad server programmed as a software application operating on said mobile device, said buyer profile data elements including buyer-specified advertising content, including at least one of a seller, a product or a service, said buyer profile data elements also including a buyer-specified geographic area, said buyer profile data elements comprising preferred offerings of said buyer;
storing with said ad server advertising videos played by said buyer on said mobile device in said local database, said stored advertising videos based on said preferred offerings of said buyer;
playing a video stream with an external application on said mobile device, said external application programmed as a software application operating on said mobile device, said video stream including video program content and advertising video content, said external application using a media player to play said video stream, said media player programmed as a software application operating on said mobile device, said media player capable of being controlled by said ad server;
transmitting over said mobile network with said advertising video distribution system advertising video content to said mobile device over said mobile network, said advertising video content including advertising videos;
receiving over said mobile network at said mobile device and said external application said advertising video content and said advertising videos; and
replacing with said media player under the control of said ad server at least one of said transmitted advertising videos with said advertising videos associated with said preferred offerings of said buyer during said playing of said video stream.

11. The method of claim 10 further comprising replacing all the transmitted advertising videos with said advertising videos associated with said preferred offerings.

12. The method of claim 10 wherein said step of

13. The method of claim 10 further comprising:

14. The method of claim 10 further comprising:

15. The method of claim 10 wherein.

16. The method of claim 10 wherein.

17. The system of claim 15 wherein said.

18. The system of claim 16 wherein said.

19. The system of claim 15 wherein said.

20. A non-transitory, machine-readable storage media having executable instructions for causing a plurality of processors within a plurality of computers to perform a method of providing advertising videos to buyers within a computer-based distribution system, said computer-based distribution system including a computer-based mobile network, said computer based mobile network coupled to a computer-based mobile device and at least one computer-based advertising video distribution system operated by an advertising video provider, each computer-based device, server and system having a processor and an associated memory for storing instructions executed by said processors, said mobile device using said processor for executing programs on said mobile device, said machine-readable storage media having steps for performing the method of:
activating a user interface on said mobile device by a buyer;
storing buyer profile data elements in a local database on said mobile device by said buyer using said user interface, said buyer profile data elements being stored using an ad server on said mobile device coupled to said local database, said ad server programmed as a software application operating on said mobile device, said buyer profile data elements including buyer-specified advertising content, including at least one of a seller, a product or a service, said buyer profile data elements also including a buyer-specified geographic area, said buyer profile data elements comprising preferred offerings of said buyer;
storing with said ad server advertising videos played by said buyer on said mobile device in said local database, said stored advertising videos based on said preferred offerings of said buyer;
playing a video stream with an external application on said mobile device, said external application programmed as a software application operating on said mobile device, said video stream including video program content and advertising video content, said external application using a media player to play said video stream, said media player programmed as a software application operating on said mobile device, said media player capable of being controlled by said ad server;
transmitting over said mobile network with said advertising video distribution system advertising video content to said mobile device over said mobile network, said advertising video content including advertising videos;
receiving over said mobile network at said mobile device and said external application said advertising video content and said advertising videos; and
replacing with said media player under the control of said ad server at least one of said transmitted advertising videos with said advertising videos associated with said preferred offerings of said buyer during said playing of said video stream.
